(19) United States
(12) Patent Application Publication
(10) Pub. No.: US 2025/0390482 A1
(43) Pub. Date: Dec. 25, 2025

(54) DYNAMIC TABLES WITH EXTERNALLY MANAGED ICEBERG SOURCE TABLES

(71) Applicant: Snowflake Inc., Bozeman, MT (US)

(72) Inventors: Vladimir Lifliand, Sammamish, WA (US); Daniel E. Sotolongo, Seattle, WA (US); Attila-Péter Tóth, Bellevue, WA (US); Matthew Uhlar, Seattle, WA (US)

(21) Appl. No.: 19/308,689

(22) Filed: Aug. 25, 2025

Related U.S. Application Data
(63) Continuation-in-part of application No. 18/679,063, filed on May 30, 2024.

(51) Int. Cl. G06F 16/22; G06F 16/14

(52) U.S. Cl. CPC G06F 16/2282; G06F 16/14; G06F 16/2255

(57) ABSTRACT

Provided herein are systems and methods for configuring dynamic tables with externally-managed Iceberg source tables. An example method for updating a dynamic table using data from an Iceberg source table includes generating, for each row in an Iceberg source table, a row identifier derived from immutable metadata associated with a physical storage location of the row and a position of the row within the physical storage location. The method further includes generating, for each of a first version and a second version of the Iceberg source table, a set of the row identifiers by computing the row identifier for each row present in the respective version. The sets of the row identifiers are compared between the first version and the second version of the Iceberg source table to identify changes at a row level. A dynamic table associated with the Iceberg source table is updated based on the identified changes.

### PRIORITY CLAIM

This application is a Continuation-in-Part of U.S. patent application Ser. No. 18/679,063, filed May 30, 2024, the contents of which are incorporated herein by reference.

### TECHNICAL FIELD

Embodiments of the disclosure generally relate to databases and, more specifically, to a database object type (e.g., a dynamic table or DT) and the configuration of DTs with externally managed Iceberg source tables.

### BACKGROUND

Databases are widely used for data storage and access in computing applications. A goal of database storage is to provide enormous amounts of information in an organized manner so that it can be accessed, managed, updated, and shared. Data may be organized into rows, columns, and tables in a database. Different database storage systems may be used to store different types of content, such as bibliographic, full text, numeric, and image content. Further, in computing, different database systems may be classified according to the organizational approach of the database. There are many different types of databases, including relational, distributed, cloud, object-oriented, and others.

Databases commonly organize data into tables, which may be joined, queried, modified, or deleted using structured query language (SQL) or similar mechanisms. These tables can store varying volumes of data and are accessed by a range of users within an organization or through external interfaces such as web applications or APIs. In modern data architectures, tables may reside in different storage systems, including cloud-based and distributed environments, and may be managed internally by the database system or externally by third-party data lake formats such as Apache Iceberg (also referred to as Iceberg).

The performance and efficiency of database operations depend on both the underlying compute and storage infrastructure of a network-based database system, as well as the ability to manage and process data changes effectively. In large-scale environments, data is often partitioned across files or objects, and changes to the data may occur through various external or internal processes. Managing the flow of data, configuring queries, and ensuring that tables reflect the latest state of the underlying data can present significant operational challenges. In particular, tracking changes, orchestrating refreshes, and maintaining consistency between tables and their sources can be complex and resource-intensive, especially when the network-based database system uses external or heterogeneous data sources that do not provide built-in mechanisms for change tracking.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager using a DT manager, in accordance with some embodiments of the present disclosure.

FIG. 3 is a block diagram illustrating components of an execution platform, in accordance with some embodiments of the present disclosure.

FIG. 4 is a diagram illustrating an example data enrichment pipeline using dynamic tables, in accordance with some embodiments of the present disclosure.

FIG. 5 is a diagram of a view graph of DTs associated with different lag targets, in accordance with some embodiments of the present disclosure.

FIG. 6 is a diagram of a task graph of DTs associated with scheduled refreshes at different times according to individual lag targets, in accordance with some embodiments of the present disclosure.

FIG. 7 is a diagram illustrating the use of data manipulation language (DML) commands and time travel queries to compute an updated set of a DT with respect to specific versions of its base relations, in accordance with some embodiments of the present disclosure.

FIG. 8 is a diagram of using a CHANGES clause in connection with query processing, in accordance with some embodiments of the present disclosure.

FIG. 9 is a diagram of a stream object configuration for a table, in accordance with some embodiments of the present disclosure.

FIG. 10 is a diagram of shared views, in accordance with some embodiments of the present disclosure.

FIG. 11 is a diagram of a stream object based on a complex view, in accordance with some embodiments of the present disclosure.

FIG. 12 is a diagram of a view evolution, in accordance with some embodiments of the present disclosure.

FIG. 13 is a diagram of a dynamic table refresh, in accordance with some embodiments of the present disclosure.

FIG. 14 is a diagram illustrating the determination of changes (or delta (Δ)) to a base table for a DT refresh, in accordance with some embodiments of the present disclosure.

FIG. 15 is a block diagram illustrating files defining an Iceberg table, in accordance with some embodiments of the present disclosure.

FIG. 16 is a diagram illustrating table specifications associated with dynamic tables, including managed dynamic Iceberg tables, in accordance with some embodiments of the present disclosure.

FIG. 17 is a diagram of compute nodes that can be used to instantiate the creation of different types of tables, including a managed dynamic Iceberg table, in accordance with some embodiments of the present disclosure.

FIG. 18 is a flow diagram illustrating the operations of a database system in performing a method for configuring managed dynamic Iceberg tables, in accordance with some embodiments of the present disclosure.

FIG. 19 is a diagram illustrating the computation and reduction of row-level changes between two table versions, in accordance with some embodiments of the present disclosure.

FIG. 20 is a diagram illustrating row actions and value aggregation for table versions with non-overlapping row sets, in accordance with some embodiments of the present disclosure.

FIG. 21 is a diagram illustrating the relationship between an unmanaged Iceberg table and multiple dynamic tables consuming its partitions, in accordance with some embodiments of the present disclosure.

FIG. 22 is a diagram illustrating the process of merge-on-read implementation for unmanaged Iceberg tables, including the creation and management of combined partitions and delta files, in accordance with some embodiments of the present disclosure.

FIG. 23 is a diagram illustrating the use of partition registration and unregistration to identify row-level inserts and deletes in dynamic tables with unmanaged Iceberg sources under merge-on-read semantics, in accordance with some embodiments of the present disclosure.

FIG. 24 is a diagram illustrating the consolidation and propagation of row-level changes through dynamic tables consuming data from unmanaged Iceberg tables using merge-on-read operations, in accordance with some embodiments of the present disclosure.

FIG. 25 is a flow diagram illustrating the operations of a database system in performing a method for configuring a dynamic table with an externally managed Iceberg source table, in accordance with some embodiments of the present disclosure.

FIG. 26 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internally in the data platform, a given file is referred to herein as an “internal file” and may be stored in (or at, or on, etc.) what is referred to herein as an “internal storage location.” If stored externally to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As is known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured file types, semi-structured file types, and structured file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “table” indicates mutable rows supporting time travel up to a retention period.

As used herein, the term “view” indicates a named SELECT statement, conceptually similar to a table. In some aspects, a view can be secure, which prevents queries from indirectly getting information on the underlying data.

As used herein, the term “materialized view” indicates a view that is eagerly computed rather than lazily (e.g., as a standard view). In some aspects, the efficient implementation of materialized views overlaps with change tracking functionality.

As used herein, the term “CHANGES clause” indicates a syntactic modifier on a FROM clause indicating that a SELECT statement should return the changes that occurred to the specified table between two given times (docs). In some aspects, several different change types can be requested:
(a) the default type (also referred to as delta) finds the smallest set of changes that could account for the difference between the tables at the given times;
(b) the append-only type only finds rows that were appended to the table; and
(c) the audit type computes all changes made between the given times, even if they cancel out.

In some aspects, dynamic tables can be used to improve functionalities provided by tasks and materialized views (MVs). As used herein, the term “dynamic table” (or DT) indicates data that is the result of a query, which can be periodically updated and queried. Tasks are powerful, but the conceptual model may limit their usability. Most use cases for tasks can be satisfied with tasks combined with stored procedures, streams, data manipulation language (DML), and transactions. Streams on views can be used to facilitate stateless incremental computations. Some drawbacks associated with tasks (which can be successfully addressed with DTs) include the following: (a) backfill workflows must be implemented and orchestrated manually, and (b) stateful operators (GroupBy, outer joins, windows) cannot be cleanly incremented by streams. As used herein, the terms “dynamic table” (or DT) and “materialized table” (or MT) are used interchangeably.

In some aspects, a DT can be created using a table definition that includes a query and a lag duration value. The lag duration value can indicate the maximum time period that a result of a prior query refresh lags behind the current time instance.

As used herein, the term “base object” indicates a data object that a dynamic table can depend on (e.g., a query associated with the dynamic table is applied to such base object). Example base objects include a base table, a base view, and a base function (e.g., a base user-defined function or UDF).

Drawbacks of existing techniques addressed by the present disclosure relate to the field of software, specifically database systems and data engineering platforms that support dynamic tables and external data lake formats such as Apache Iceberg. The drawbacks arise when dynamic tables are configured to consume data from externally managed, or unmanaged Iceberg tables. In these scenarios, the underlying table format does not provide persistent row-level identifiers or internal change tracking columns. As a result, it becomes difficult to accurately detect and process incremental changes between table versions.

Symptoms of the drawbacks include inefficient refresh operations, excessive data movement, and increased compute resource consumption. For example, when files or partitions are rewritten in unmanaged Iceberg tables, the system cannot distinguish between actual data changes and unchanged rows. This leads to scenarios where entire files are treated as new or deleted, even if only a small subset of rows has changed. The lack of row-level identity results in write amplification and unnecessary propagation of changes through downstream data pipelines.

The drawbacks occur in environments where dynamic tables are integrated with external data sources that do not natively support change tracking. This is common in cloud-based data platforms that use open table formats for interoperability. The absence of persistent row identifiers and change tracking metadata in unmanaged Iceberg tables is a prerequisite for the problem. The issue is further compounded when data is frequently updated or partitioned by external engines.

The impact of the drawbacks can be significant. Users and systems experience increased latency, higher operational costs, and reduced efficiency in data processing workflows. Data pipelines may become less reliable, and downstream analytics can be affected by unnecessary data refreshes. If the issue is not addressed, organizations may face scalability challenges and resource constraints. Potential causes include the design of external table formats that do not maintain row-level identity across file rewrites, and the lack of integration between dynamic table management systems and external metadata. The use of copy-on-write and merge-on-read update models in Iceberg tables further complicates change detection, as row identifiers may be recomputed or lost during file operations.

Existing solutions have attempted to address the problem by using file-level or partition-level metadata to infer changes. Some systems rely on full refreshes or manual intervention, which are inefficient and do not scale well. Recommendations for incremental refreshes are limited by the absence of persistent row identifiers. Workarounds such as hashing row content or using external logs have been partially successful but do not fully resolve the issue. The disclosed techniques seek to provide a more robust and efficient approach to incremental change tracking in dynamic tables consuming data from unmanaged Iceberg sources.

In some aspects, MVs can be used as query accelerators. Simple queries may be sufficient, and only aggregating operations are supported (e.g., no joins and no nested views are supported). Additionally, implementation costs may be insignificant, and users may be exposed to less visibility and control.

In some aspects, DTs can be used to target data engineering use cases. While MVs can support only aggregating operations (e.g., a single GroupBy on a single table), DTs remove query limitations and allow joining and nesting in addition to aggregation. Additional benefits of DTs include providing controls over cost and table refresh operations, automating common operations, including incrementalization and backfill, and providing a comprehensive operational experience.

In comparison to other query processing techniques (e.g., extract-transform-load (ETL) and data pipeline solutions such as Airflow, Data Build Tool (DBT), streams, and tasks), the disclosed techniques are associated with the following additional advantages of using DTs: providing a declarative structured query language (SQL) interface to facilitate specifying the pipelines compared to preceding solutions; refreshes are performed incrementally (i.e., the cost scales with the size of the changes to inputs), reducing the cost compared to a “full refresh” solutions like the DBT development framework; incrementalization is done automatically, which results in simplifying the queries users have to write compared to traditional ETL systems like Airflow; DTs are integrated with the database, making it easier to access source data; and DTs are similar to MVs, but targeted at the use case of building data pipelines, not accelerating interactive query workloads (compared to MVs, DTs impose fewer restrictions on allowed queries, but cannot be automatically substituted into queries like MVs).

Apache Iceberg is an open-source software (OSS) “table format” that allows data engineers to manage table-like datasets stored in Parquet files on blob storage. Aspects of the present disclosure provide techniques for configuring database object types (e.g., a dynamic table), including configuring managed dynamic Iceberg tables.

The disclosed techniques can provide the following advantages of managed dynamic Iceberg tables:
(a) Control. Instead of using specific file formats, managed dynamic Iceberg tables use open table and file formats and store data in customer-supplied storage.
(b) Cost. Managed dynamic Iceberg tables can be configured to use customer-supplied storage. Instead of copying data between systems, customers can now work with a single set of data managed by a network-based database system (NBDS), stored, and billed separately.
(c) Ecosystem. Tools that know how to work with Iceberg and Parquet will work with NBDS-managed dynamic Iceberg tables, while the NBDS provides a single pane of glass for security, management, maintenance, and a variety of workloads for collaboration, data science, and applications. Dynamic Iceberg tablescan be configured to interoperate cleanly with tables that use NBDS-specific table and file formats.

DTs are a feature that allows the definition of data pipelines to be configured declaratively in terms of SELECT queries. The NBDS can manage orchestrating refreshes on behalf of the user and refreshing the tables incrementally.

As used herein, the term “managed Iceberg table” indicates that an NBDS is the source of truth for the contents of the Iceberg table and periodically exports manifest files to object storage. These tables support DML operations by the NBDS, which maintains change-tracking columns.

As used herein, the term “Apache Iceberg table” includes a table format for large-scale analytic datasets that stores data in files and maintains metadata for partitioning, versioning, and schema evolution, commonly used in cloud-based data lake environments.

As used herein, the term “combined partition” includes a logical grouping of a base file and its associated delta file in a merge-on-read table, representing the current state of rows after applying updates and deletes.

As used herein, the term “copy-on-write update model” includes a data modification approach in which updates or deletes result in the creation of new files containing the modified data, with the original files remaining unchanged until replaced.

As used herein, the term “delta file” includes a file that records changes, such as deletes or updates, to a base file in a merge-on-read table, allowing the system to reconstruct the current state of the data by applying the delta to the base file.

As used herein, the term “externally managed table source” is interchangeable with “externally managed source table” and includes a table whose data and metadata are controlled by an external system or engine, rather than the database system consuming the table, and which may lack persistent row-level change tracking.

As used herein, the term “managed” table (e.g., managed dynamic table or managed dynamic Iceberg table) indicates that the NBDS is the source of truth for the contents of the table, and the NBDS periodically exports manifest files to object storage. Additionally, managed tables support DML operations by the NBDS, which maintains change-tracking columns. In some aspects, the change-tracking column can be configured as part of the table and can indicate a list of operations performed on the table between different table versions. In this regard, managed tables are those where the subject system (e.g., the NBDS) is the metastore/catalog for the table. As used herein, the term “unmanaged” table indicates a table where an external catalog controls the table and the subject system (e.g., the NBDS) and integrates with that catalog to work with the table, but does not assume control of the table.

As used herein, the term “file name” includes a string or identifier that uniquely specifies the location or identity of a file within a storage system, used for referencing data files in external table formats.

As used herein, the term “lag duration” includes a configurable time interval that specifies the maximum allowable delay between the current state of a dynamic table and the most recent state of its source data.

As used herein, the term “materialized view” includes a database object that stores the results of a query and is periodically refreshed, but may be subject to limitations in incremental change tracking compared to dynamic tables.

As used herein, the term “merge-on-read update model” includes a data modification approach in which changes are recorded in separate delta files and merged with base files during read operations to reconstruct the current state of the data.

As used herein, the term “partition identifier” includes a value or metadata attribute that uniquely identifies a partition within a table, used for organizing and referencing subsets of data in external table formats.

As used herein, the term “physical storage location” includes the specific file, partition, or address within a storage system where a row of data is stored, as referenced in the computation of row identifiers.

As used herein, the term “row identifier” includes a deterministically generated value that uniquely identifies a row within a table, derived from immutable metadata such as file name and row position, and used for incremental change tracking.

As used herein, the term “row ordinal position” includes the numerical position of a row within a file or partition, used in combination with file metadata to generate a unique row identifier.

As used herein, the term “table-unique identifier” includes a value that uniquely distinguishes a table within a database or storage system, ensuring global uniqueness of row identifiers across multiple tables.

As used herein, the term “version of a table” includes a specific state or snapshot of a table at a given point in time, used for comparing changes between different table versions during incremental refresh operations.

A DT manager of an NBDS can perform the disclosed techniques. Dynamic Iceberg tables can be configured as a combination of both dynamic tables and Iceberg tables. This integration allows for:
(a) Dynamic tables to be stored as managed Iceberg tables (e.g., NBDS-managed Iceberg tables); and
(b) Dynamic tables to consume from managed Iceberg base tables.

In some aspects, the dynamic Iceberg tables' incremental refresh can rely on the following configurations:
(a) Access to deleted rows.

In order to propagate the effects of deletion from sources, dynamic tables can be configured to read data that was deleted from prior versions to the source.
(b) Support for change-tracking columns.

Incremental refresh uses a set of internal columns called change-tracking columns to efficiently compute the changes between versions of a table. In some aspects, change-tracking columns are not exposed to users.

In some aspects, the NBDS is the source of truth for managed Iceberg tables, which support DML operations by the NBDS and maintain change-tracking columns for managed dynamic and non-dynamic Iceberg tables. Since the NBDS manages the table, all table metadata, including table versions, change_tracking columns, and access to deleted rows, are readily available. In some aspects, NBDS-managed files are written to the customer-supplied object storage location specified during the dynamic Iceberg table creation.

Although embodiments described herein mention Iceberg tables, it is appreciated that the subject system is enabled to support any appropriate external table format (e.g., Apache Hive ACID, Apache Hudi, and the like). Moreover, the subject system is enabled to support any appropriate file format in addition to the aforementioned Apache Parquet file format (e.g., CSV, XML, ORC, Avro, JSON, and the like).

The disclosed techniques further present a technical solution that addresses the challenge of enabling incremental change tracking and refreshes for dynamic tables that consume data from externally managed table sources, such as unmanaged Apache Iceberg tables. The solution is implemented within a database system or data engineering platform (e.g., the disclosed techniques are configured and performed by a DT manager of an NBDS), and is designed to operate in environments where the external table format does not provide persistent row-level identifiers or internal change tracking columns.

The solution associated with the disclosed techniques begins by deterministically generating a unique row identifier for each row in the externally managed table. The row identifier can be derived from immutable metadata associated with the physical storage location of the row and the position of the row within that location. Specifically, the row identifier is constructed by concatenating the file name or file path with the row's ordinal position within the file, and may further include a table-unique identifier to ensure global uniqueness. In some configurations, a hash function is applied to the concatenated value to prevent collisions and maintain consistency. The row identifier is designed to be stable and reproducible for each row, even as files are rewritten or partitions are reorganized.

To implement the solution, the DT manager scans the externally managed table source and computes the row identifiers for all rows in both the current and previous versions of the table. The DT manager then compares the sets of row identifiers between the two versions to identify changes at the row level. Row identifiers present in the current version but not in the previous version are classified as inserted rows. Row identifiers present in the previous version but not in the current version are classified as deleted rows. Row identifiers present in both versions are classified as unchanged rows. This comparison enables the system to accurately detect incremental changes without relying on internal change tracking columns.

In some aspects, the disclosed techniques are integrated into a dynamic table refresh workflow. When a refresh is triggered, either automatically on a schedule or in response to a user request, the system applies only the net changes to the dynamic table. This incremental update process reduces unnecessary recomputation and write amplification, as only the rows that have actually changed are processed and propagated through downstream data pipelines. The solution supports both copy-on-write and merge-on-read update models in Apache Iceberg tables, and is compatible with other external or internal table formats that lack persistent row-level change tracking.

In some aspects, implementation of the disclosed techniques is based on access to the metadata of the external table source, including file names, file paths, partition identifiers, and row ordinal positions. The DT manager can parse and process this metadata during each refresh operation. In some cases, the disclosed techniques rely on delta files (or delta metadata files) or similar metadata structures to track the registration and unregistration of partitions, which are used to infer row-level inserts and deletes. The disclosed techniques can be implemented using database management software, data engineering frameworks, or custom code modules that interface with the external table format.

In some aspects, the DT manager can utilize delta metadata files to determine which partitions have been registered or unregistered. The DT manager treats rows from unregistered partitions as deletes and rows from registered partitions as inserts. This mechanism enables the system to track partition-level changes that indicate row-level modifications.

The rationale behind the disclosed techniques is based on the principle that immutable metadata associated with the physical storage location and position of a row can serve as a surrogate for persistent row-level identifiers. By leveraging this metadata, the DT manager can reconstruct the identity of each row across table versions, enabling accurate incremental change tracking. This approach can be used in environments where the external table format does not natively support change tracking or row-level identity.

In this regard, the disclosed techniques address technical challenges related to inefficient refresh operations, excessive data movement, and increased compute resource consumption. By enabling incremental updates, the solution targets the subsystems responsible for dynamic table management, change detection, and data pipeline orchestration. The expected outcomes of applying the solution include reduced latency, lower operational costs, and improved efficiency in data processing workflows. Performance metrics may include decreased refresh times, reduced data movement, and minimized write amplification.

Examples and illustrations in the document include diagrams showing the computation and reduction of row-level changes between table versions, the handling of partition registration and unregistration, and the propagation of changes through dynamic tables consuming data from unmanaged Iceberg sources. These examples demonstrate the application of the solution in various scenarios, including both copy-on-write and merge-on-read update models. The disclosed techniques can also be configured to be scalable and compatible with a wide range of external table formats and data engineering environments.

In some aspects, the DT manager can reduce write amplification by avoiding the reprocessing of unchanged rows when files are rewritten due to copy-on-write operations. The DT manager can distinguish between actual data changes and file reorganization activities, preventing unnecessary processing of rows that have not actually changed.

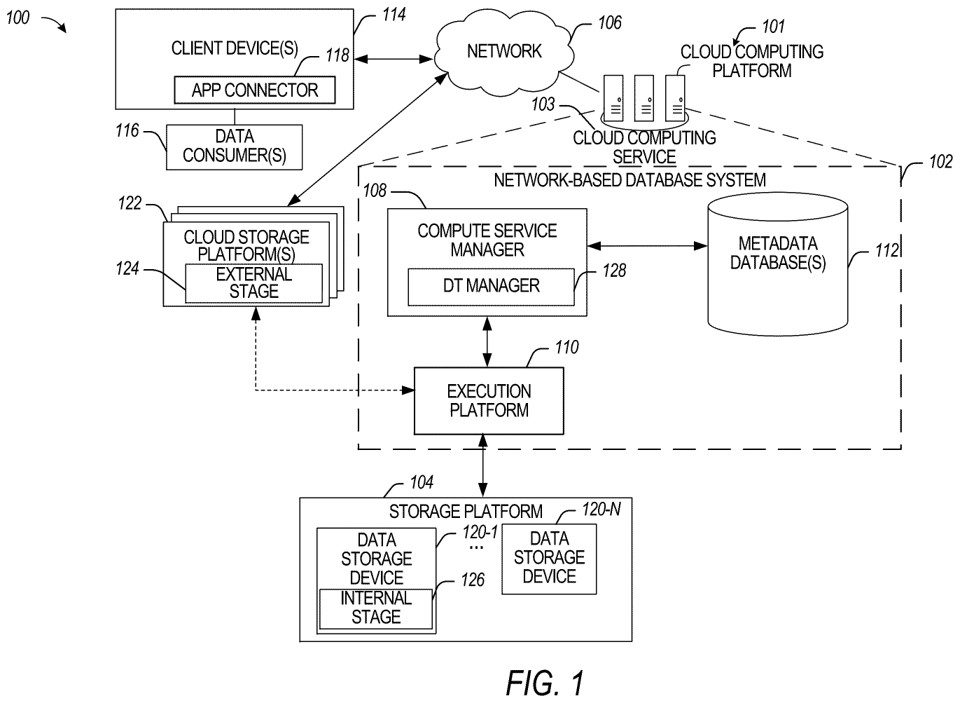

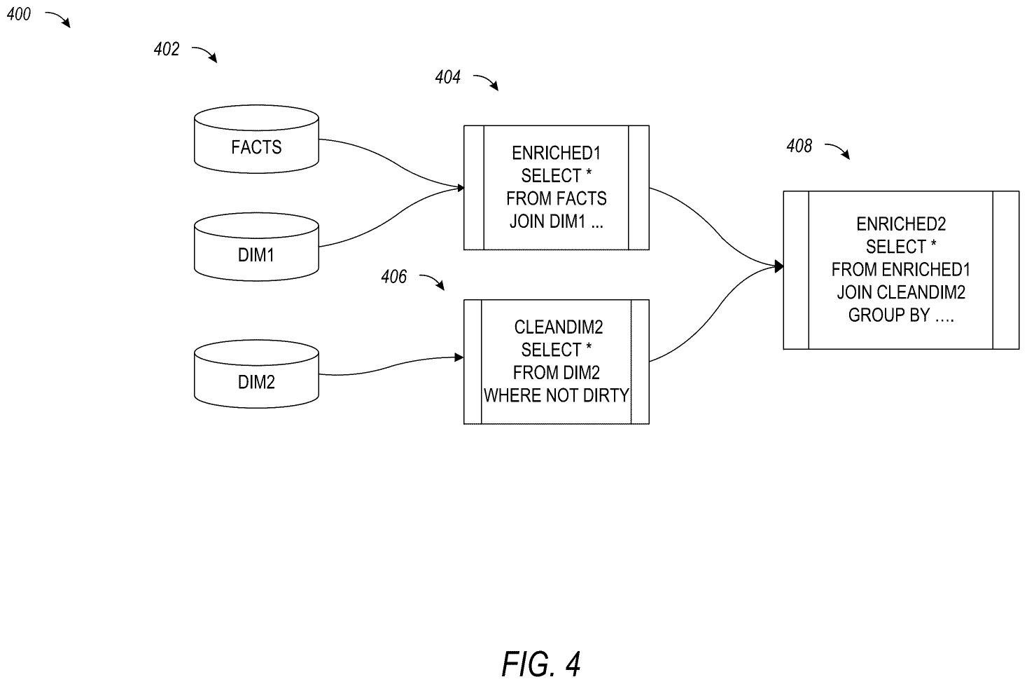

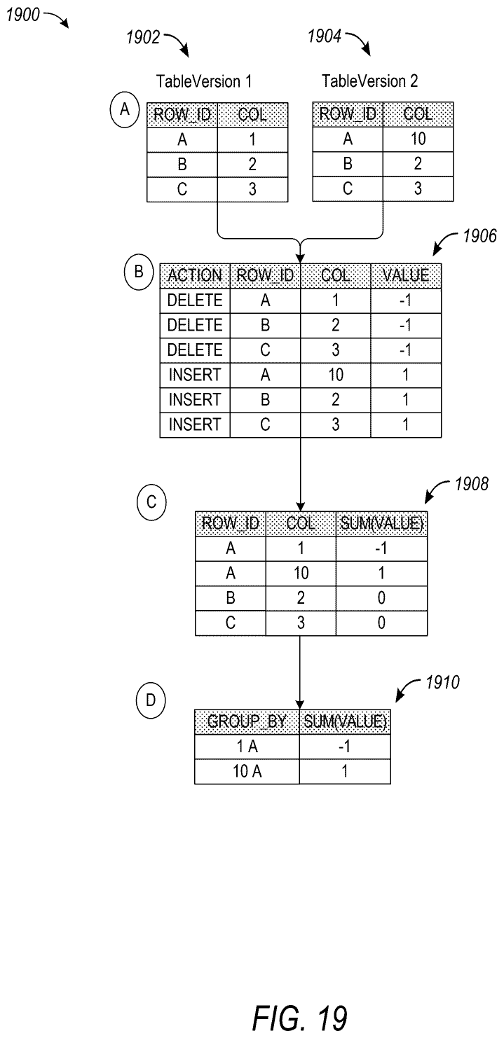

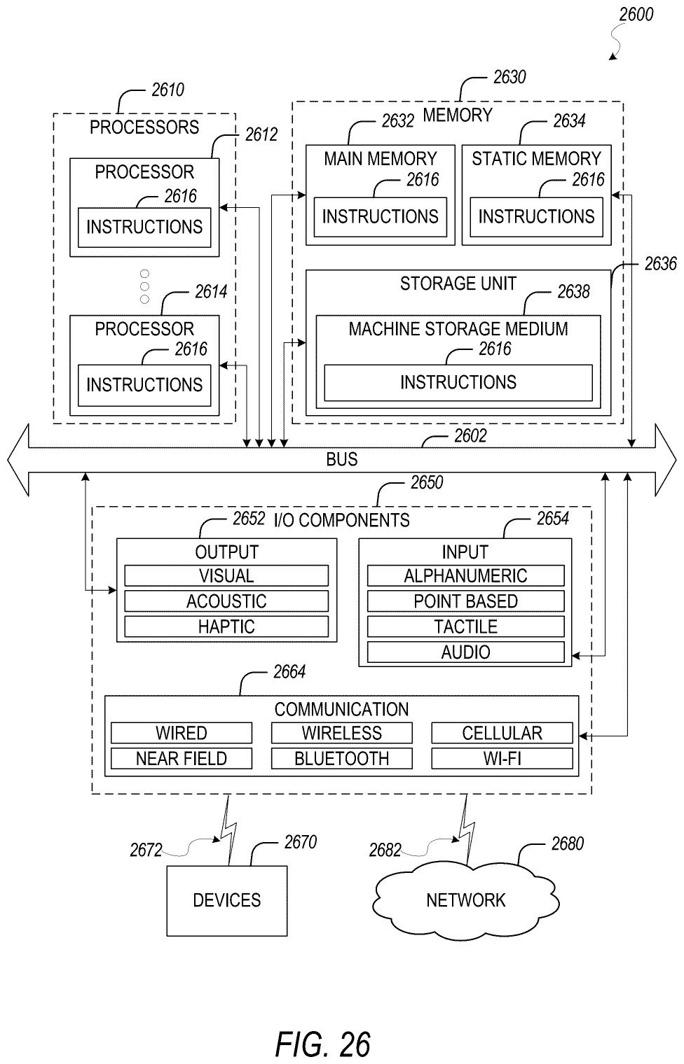

The various embodiments that are described herein are described with reference, where appropriate, to one or more of the various figures. An example computing environment using a DT manager to configure DTs is discussed in connection with FIGS. 1-3. Example configuration and functions associated with the DT manager and configuring managed dynamic Iceberg tables are discussed in connection with FIGS. 4-18. Example configurations associated with using dynamic tables with externally managed Iceberg source tables are discussed in connection with FIGS. 19-25. A more detailed discussion of example computing devices that may be used in connection with the disclosed techniques is provided in connection with FIG. 26.

FIG. 1 illustrates an example computing environment 100 that includes a database system in the example form of a network-based database system 102 (also referred to as NBDS or NBDS 102), in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of NBDS or a cloud data platform. For example, in some aspects, the computing environment 100 may include a cloud computing platform 101 with the NBDS 102, storage platforms 104, and cloud storage platforms 122. The cloud computing platform 101 provides computing resources and storage resources that may be acquired (purchased) or leased (e.g., by data providers and data consumers), and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the DT-related functions described herein). The cloud computing platform 101 may include a three-tier architecture: data storage (e.g., storage platforms 104 and 122), an execution platform 110, and a compute service manager 108 providing cloud services (e.g., services associated with performing automatic evolution of DTs using a DT manager 128).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types-on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the NBDS 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the NBDS 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 116 via network 106. The NBDS 102 is a network-based system used for reporting and analysis of integrated data from one or more disparate sources, including one or more storage locations within the cloud storage platform 104. The storage platform 104 comprises a plurality of computing machines and provides on-demand computer system resources, such as data storage and computing power, to the NBDS 102.

The NBDS 102 comprises a compute service manager 108, an execution platform 110, and one or more metadata databases 112. The NBDS 102 hosts and provides data reporting and analysis services (as well as additional services such as the disclosed functions associated with the automatic evolution of DTs) to multiple client accounts, including an account of the data provider associated with client device 114 and an account of the data consumer 116. In some embodiments, the compute service manager 108 comprises the DT manager 128, which can be used in connection with the disclosed DT-related functions. Example DT-related functions include configuring managed dynamic Iceberg tables. In some aspects, the DT manager 128 is configured to enable incremental change tracking and refreshes for dynamic tables that consume data from externally managed table sources, such as unmanaged Apache Iceberg tables, by deterministically generating unique row identifiers for each row using immutable metadata from the physical storage location and row position. The DT manager 128 scans both current and previous versions of the external table, computes and compares sets of row identifiers to classify rows as inserted, deleted, or unchanged, and applies only the net changes to the dynamic table during refresh operations. This process operates without relying on internal change tracking columns and supports both copy-on-write and merge-on-read update models. The DT manager 128 parses metadata such as file names, file paths, partition identifiers, and row ordinal positions, and may utilize delta files or similar structures to track partition registration and unregistration for inferring row-level inserts and deletes. By leveraging this metadata-driven approach, the DT manager addresses challenges of inefficient refreshes, excessive data movement, and increased compute resource consumption, resulting in reduced latency, lower operational costs, and improved efficiency in data processing workflows across various external table formats and environments. A more detailed description of the functions provided by the DT manager 128 is provided in connection with FIGS. 4-25.

The compute service manager 108 coordinates and manages operations of the NBDS 102. The compute service manager 108 also performs query optimization and compilation and manages clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the NBDS 102. The data provider may utilize application connector 118 at the client device 114 to submit data storage, retrieval, and analysis requests to the compute service manager 108 as well as to access or configure other services provided by the compute service manager 108 (e.g., services associated with the disclosed DT-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analyzing, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., the disclosed DT-related functions) offered by the NBDS 102 via network 106.

The compute service manager 108 is also coupled to one or more metadata databases 112 that store metadata about various functions and aspects associated with the NBDS 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to the storage platform 104 and at least one cloud storage platform 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3TM storage systems, or any other data storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on the at least one cloud storage platform 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and storage platform 104 are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the NBDS 102. Thus, in the described embodiments, the NBDS 102 is dynamic and supports regular changes to meet the current data processing needs.

During typical operations, the NBDS 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from and store data to any of the data storage resources in the cloud storage platform 104.

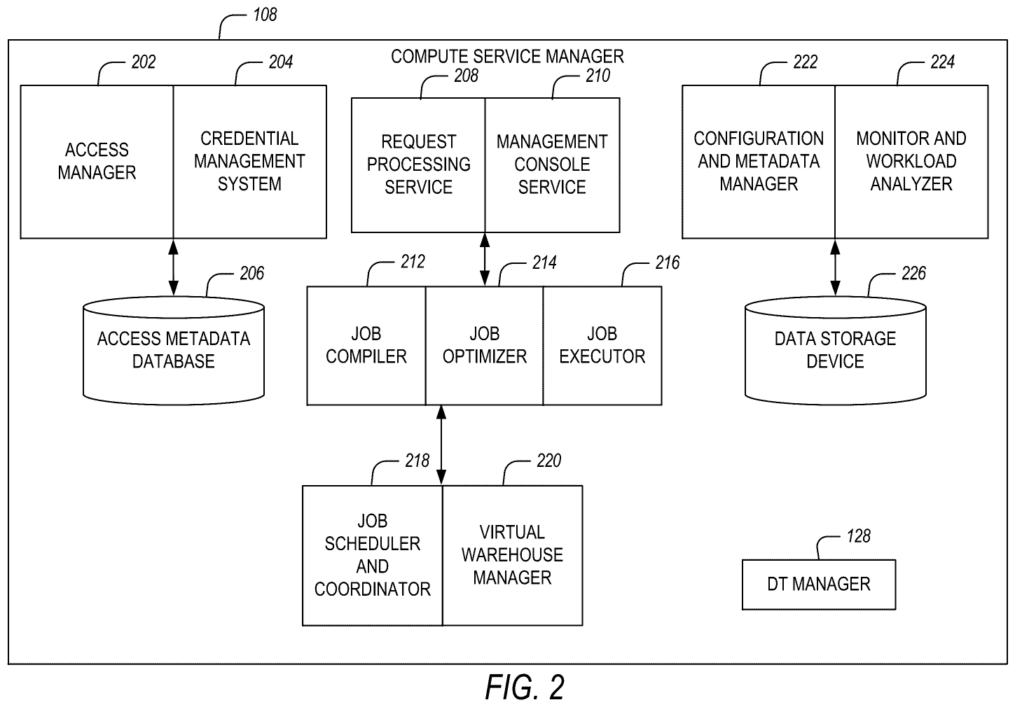

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports administrators and other system managers' access to various systems and processes. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the NBDS 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the NBDS 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the DT manager 128, which can be used in connection with DT-related functions disclosed herein, such as configuring managed dynamic Iceberg tables as well as configuring dynamic tables with externally managed Iceberg source tables.

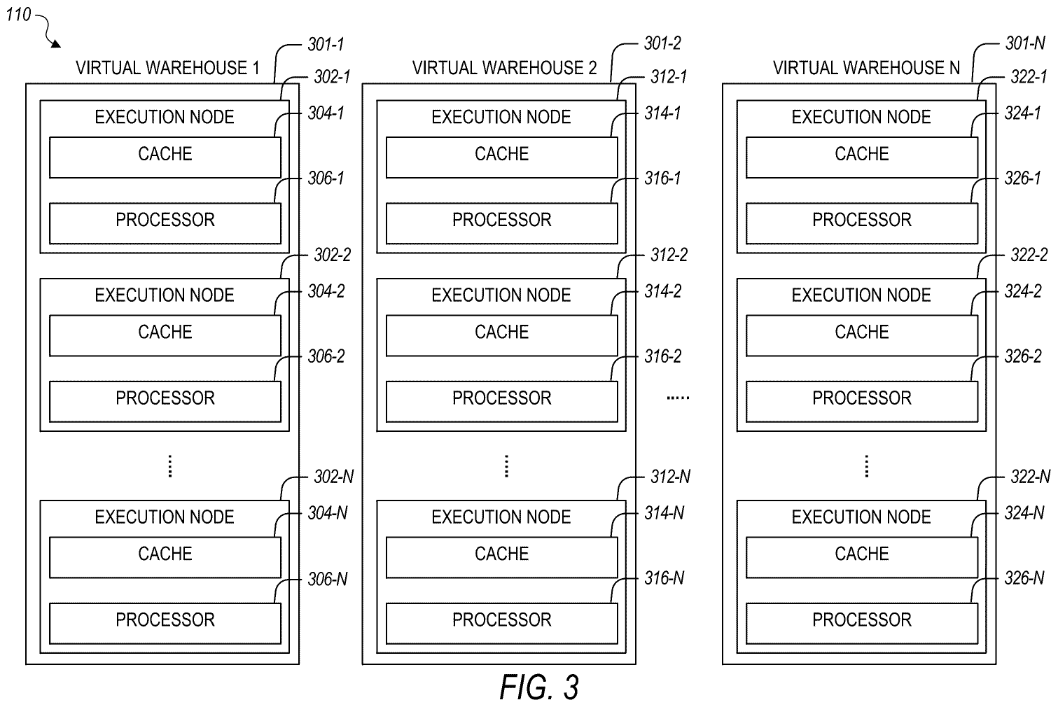

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic. New execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device. Still, the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor; alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes. This is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is helpful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while another computing system implements virtual warehouses 2 and n at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, it is replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104. Still, each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

In some aspects, DTs can be configured with the following capabilities:
(a) Incremental refresh: selection, projections (scalar functions), aggregations, and joins (inner, outer, semi, anti). In some aspects, DTs are refreshed incrementally (e.g., when the DTs contain the above-listed operations).

(b) Observability: In some aspects, a user interface (UI) with a simple view graph and account usage views can be used for monitoring.
(c) DT definition evolution can be used to configure a full refresh. In some aspects, DTs can continue functioning when they are replaced. However, updating may be based on a full (non-incremental) refresh. If consuming DTs are broken, updates may pause, and an error may be generated.
(d) Shared data: In some aspects, DTs can read shared tables and views and share them themselves.
(e) Data transformation tool (e.g., DBT) integration: a custom DBT materialization for users can be used to adopt DTs in data transformation pipelines.

In some aspects, the disclosed techniques can be used to create DTs with the following configurations: minimum lag of 1 second; nesting depth, fan-in, and fan-out of up to 1000; incremental refreshes for partitioned window functions, subqueries, lateral joins, and recursive queries; integration with other data processing features including streams, row access policies, column masking policies, external tables, directory tables, external functions, user-defined functions (UDFs), and user-defined table functions (UDTFs); support for non-deterministic functions; an interactive UI for monitoring and debugging DT pipelines; incremental DT definition evolution when queries change compatibility; automatic query rewrites into DT scans; stream-like, “append-only” transformations; continuous DML features; merge performance optimizations; and using DTs to implement other features within an NBDS including functionalities for automatic evolution of DTs.

In some aspects, DTs can be defined and orchestrated using data definition language (DDL) commands. For example, a DT can be created using the command CREATE DYNAMIC TABLE<name>[LAG=<duration>]AS <query>. In this regard, a DT can be created using a query on one or more base tables and a lag duration (also referred to as a lag or a lag duration value). The lag duration value indicates a maximum period that a result of a prior refresh of the query can lag behind a current real-time instance (e.g., a current time, which can also be referred to as a current time instance). The lag duration value can be configured as a required parameter.

In some aspects, the DDL command ALTER DYNAMIC TABLE<name>{SUSPEND|RESUME} can be used to suspend or resume a refresh (e.g., to prevent refreshes without deleting DTs entirely).

In some aspects, the DDL command ALTER DYNAMIC TABLE<name>REFRESH can be used for the manual orchestration of data pipelines. In some aspects, the DDL command SHOW DYNAMIC TABLES can be similar to the command SHOW DYNAMIC VIEWS (or SHOW MATERIALIZED VIEWS), but with additional columns to show, e.g., lag, base tables, and maintenance plan. In some aspects, when the lag duration is set to infinity, the ALTER command can be used for a manual refresh.

In some aspects, the following DDL command configurations can be used with the disclosed DT-related techniques.

The following syntax may be used with the CREATE command for creating DTs: CREATE[OR REPLACE]DYNAMIC TABLE<name>(<column_list>)[LAG=<duration>]AS<select>. LAG represents a lag duration that the table is allowed to be behind relative to the current time. The term <select> indicates the view definition and may include a selection of both tables, views, projections (scalar functions), aggregates, joins (inner, outer, semi, anti), etc. This definition can be richer than an MV view definition.

In some aspects, if LAG is not specified and the user provides a view definition that is not compatible with the current implementation, then an informative error is generated that will point to a document that details what is allowed/not-allowed. Examples of this include a selection on an MV (selects from materialized tables can be allowed, but not classic MVs). Similar to existing MVs, creation requires CREATE DYNAMIC TABLE privilege on the schema and SELECT privileges on the base tables and sources.

The following configurations may be used with the ALTER command. The command can be configured as ALTER DYNAMIC TABLE <name>{SUSPEND|RESUME}. This command allows the user to stop the DT from updating itself via its refresh strategy. A DT can remain suspended until a RESUME is executed.

In some aspects, the command ALTER DYNAMIC TABLE<name>set LAG=<duration> can be used to change the lag of the materialized table. The subsequent scheduled execution of the refresh can reflect the updated lag.

In some aspects, the command ALTER DYNAMIC TABLE <name>REFRESH[AT(<at_spec>)] can be used to initiate an immediate refresh of the DT. This command may be used with data engineering use cases that may require more direct control over refreshes. For example, it may be common for imperative data pipelines to spend a significant amount of time in an inconsistent state, with new data only partially loaded. Authors of such pipelines would not want a refresh to occur during these inconsistent periods, and they may disable automatic refresh (LAG= ‘infinity’) and invoke REFRESH when they know the database is in a consistent state.

In some aspects, the optional AT clause can be used to allow users to control the transactional time from which the DT's source data is read. Using this, they can ensure that multiple manually-orchestrated DTs are aligned correctly, even during backfills.

In some aspects, commands ALTER DYNAMIC TABLE<name>set REFRESH_MODE={INCREMENTAL|FULL|AUTO} and ALTER DYNAMIC TABLE<name> unset REFRESH_MODE can be used to change the refresh mode on the DT. The change can be reflected in the next reprocessing of the DT. Unset sets the refresh mode back to the system default. The INCREMENTAL value may be used to maintain the DT by processing changes to the source(s) incrementally. The FULL value may be used to perform a full refresh of the DT (i.e., an entire re-computation). The AUTO value indicates that the NBDS can determine whether to perform an incremental or full refresh, any may alternate between the two depending on upstream changes and the view definition.

In some aspects, the DROP DYNAMIC TABLE<name> command can be configured.

In some aspects, SHOW DYNAMIC TABLES[LIKE‘<pattern>’][IN{ACCOUNT|DATABASE[<db_name>]|[SCHEMA] [<schema_name>]}] command can be configured. The existing syntax can be kept, but the following columns can be added to the existing output:
(a) lag: the user-defined lag duration specified during creation. Unlike the existing columns, this configuration can be static.
(b) source_names: a column that has the fully qualified names of the sources used in the DT as a list, ex. [“db”.“schema”.“table”]. For a longer term, source_database_name, source_schema_name, and source_table_name can be deprecated in favor of this new column as these will be null for DTs.

In some aspects, the following variants of the EXPLAIN command may be used in connection with the disclosed DT-related functionalities (e.g., to obtain details of an operation on a DT):
(a) EXPLAIN CREATE DYNAMIC TABLE<mv>LAG=<duration>AS<query> can be used to show the refresh plan before creating a DT.
(b) EXPLAIN ALTER DYNAMIC TABLE<mv>REFRESH[AT(<at_spec>)] can be used to show the refresh plan for a DT.
(c) EXPLAIN SELECT<select>FROM<mv> can be used to show the version and plan used to resolve the DT.

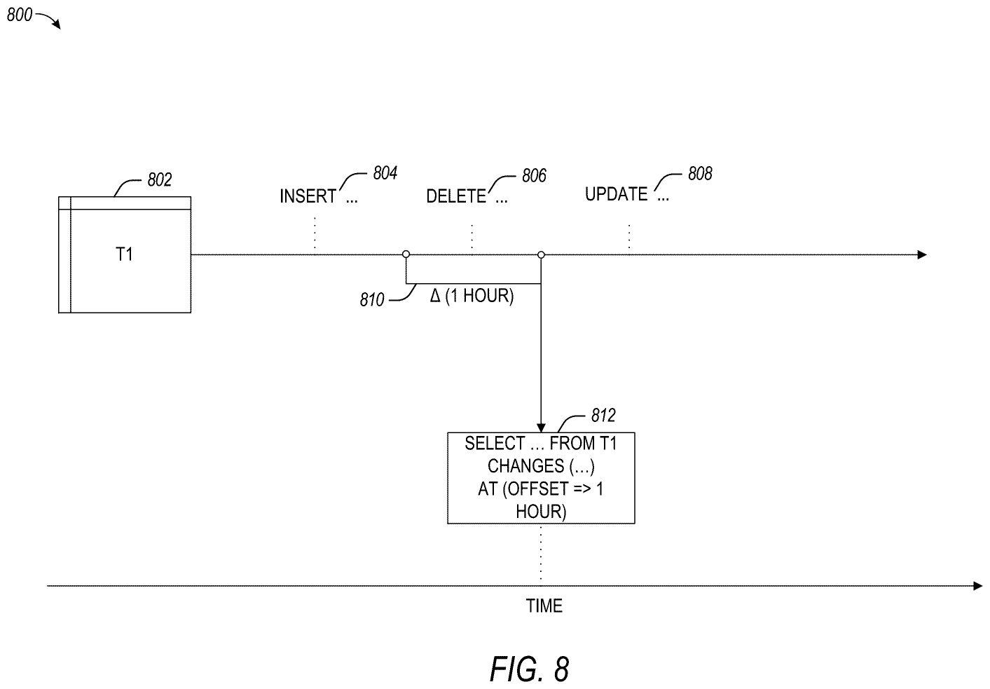

In some aspects, a stream on a DT can be created, similarly to a stream on a view (which is discussed in connection with FIG. 8-FIG. 12).

FIG. 4 is diagram 400 illustrating an example data enrichment pipeline using DTs, in accordance with some embodiments of the present disclosure.

In some aspects, DT definitions are rendered into a dependency graph, where each node in the graph is a DT query, edges indicate that one DT depends on the results of another, leaf nodes are DTs on base tables, and DDLs (e.g., DDL commands) can be used to log graph changes to a metadata database (e.g., metadata database 112), and an in-memory representation of the graph can be rendered.

Referring to FIG. 4, DT Enriched1 404 is created using a subset of base tables 402, namely, base tables Facts and Dim1. DT CleanDim2 406 is created using base table Dim2 of base tables 402. DT Enriched2 408 is created from DTs Enriched1 and CleanDim2. In this regard, the following processing sequence can be used: (a) a DT is created using other DTs; (b) the DTs (e.g., the DTs 404-408 in FIG. 4) form an acyclic dependency graph (e.g., a directed acyclic graph or DAG); a query in the final DT (e.g., DT Enriched2 408) is parsed to obtain two or more dependent DTs (e.g., DTs Enriched1 404 and CleanDim2 406); and DT refreshes can be scheduled based on the configurations of each DT.

In some aspects, DT refreshes can be scheduled at aligned time instances (or ticks) for consistency. In some aspects, DTs can be joined at consistent times without fine-grained refreshes. A user can provide a lag duration (or lag) target, and refreshes can be scheduled to meet that target. For example, a set of canonical refresh times (e.g., ticks) is selected, which align refreshes at different frequencies. In some aspects, the ticks can be determined based on the following equation: ticks={UnixEpoch+48 seconds*2^{f}*n}, where f is the frequency level, and n is the refresh instance. In some aspects, refreshes can be scheduled at the nearest tick that meets the user's lag target. Common examples of lag targets and tick periods are provided in Table 1 below:

TABLE 1

| | | | | | | | | | | |
|---|---|---|---|---|---|---|---|---|---|---|
| Target | 1 | min | 5 | min | 15 | min | 1 | hr | 25 | hr |
| Lag | | | | | | | | | | |
| Tick | 48 | sec | 3.2 | min | 12.8 | min | 51 | min | 13.6 | hr |
| Period | | | | | | | | | | |

Using the above techniques can yield alignment at two scopes: account-wide (DTs can be joined with snapshot isolation) and deployment-wide (DTs can be joined with read-committed isolation).

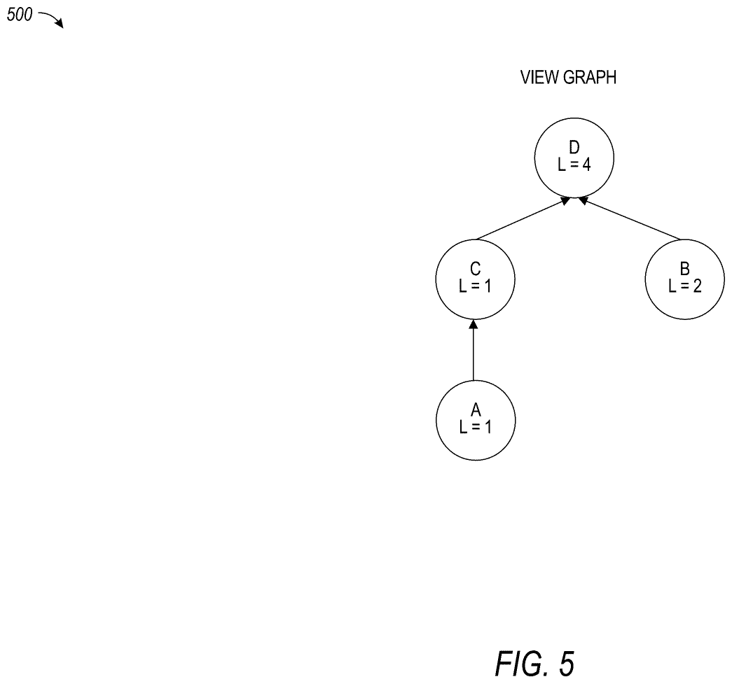

FIG. 5 is a diagram of a view graph 500 of DTs associated with different lag targets, in accordance with some embodiments of the present disclosure. Referring to FIG. 5, graph 500 is associated with a dependency relationship between DTs with different lag durations (indicated as L). For example, DT A (with lag duration L=1) feeds to DT C (with L=1). DT D (with L=4) uses data from DT C (L=1) and DT B (L=2).

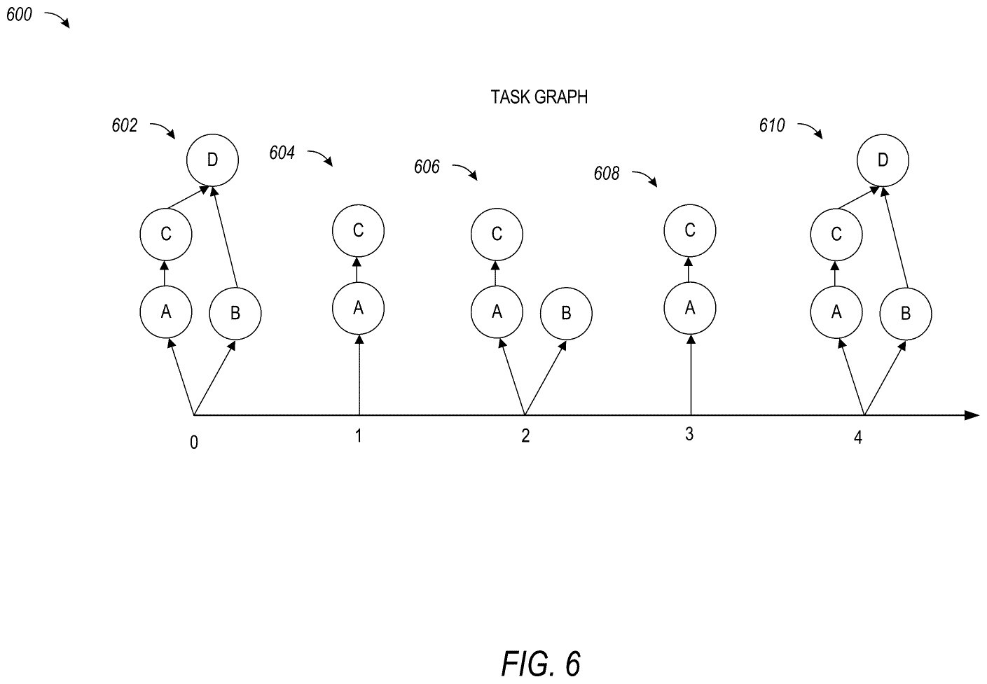

FIG. 6 is a diagram of a task graph 600 of DTs associated with scheduled refreshes at different times according to individual lag targets, in accordance with some embodiments of the present disclosure. Referring to FIG. 6, graph 600 shows scheduled refreshes of DT groups 602, 604, 606, 608, and 610 at corresponding ticks 0, 1, 2, 3, and 4. More specifically, graph 600 shows scheduled refreshes of the DTs of FIG. 5 based on their lag durations. At time instances 0 and 4 (or ticks 0 and 4), all DTs (A, B, C, and D) are refreshed. At ticks 1 and 3, DTs A and C are refreshed, and at tick 2, DTs A-C are refreshed.

As illustrated in FIG. 6, DTs can be refreshed with different refresh cadences based on the corresponding DT lag durations. In some aspects, the refresh cadences can be configured so that when the DTs are refreshed, the DTs produce results that their corresponding queries would have produced at some point in time.

In some aspects, a refresh can be configured to execute a

maintenance plan that updates the DT's physical table. In some aspects, at each tick, a rooted prefix of the DAG (e.g., the DT dependency graph) can be refreshed. A consistent snapshot of the DAG can be maintained in memory, and a compute service task can be scheduled for each connected component. The connected component task can enter a scheduling loop, which finds nodes with satisfied dependencies and starts a refresh job. In some aspects, a refresh job has a maintenance plan, which can take one of the following forms: (1) a full refresh (truncate the DT table and insert the result of running the DT definition at the tick time); and (2) incremental refresh (compute the changes in the DT since the last refresh tick and merge them into the DT table).

In some aspects, the refresh job creates table versions at the tick time. New DT table versions can be configured with a new property containing the base tables' version IDs. Retries can skip re-computation if the version has already been computed. Additionally, queries can resolve the correct version by specifying an entity version AT(DT_BASE_TIME=><ts>).

The following maintenance plan configurations can be used with the disclosed DT-related functions. The disclosed configurations can be used to maintain DTs via full refreshes and incremental updates. The disclosed design configuration can be used to ensure that DT updates preserve the DT history, which can be essential for time-travel queries to produce consistent results and for computing the updates of downstream views.

In some aspects, DTs can be maintained in the following two ways:
(a) Incremental Update. For an update tick, the set of delta changes (delta set) since the last update is computed and merged into the DT. This technique can use the following configurations: (1) all operations of the DT definition are supported for incremental maintenance, and (2) all base relations provide access to their history and can provide their delta sets.
(b) Full Refresh. For each update tick, the view definition is recomputed, and the DT is fully replaced. This technique can be used if the DT definition includes operations that still need to be supported for incremental updates or if it is not possible (or feasible) to retrieve the delta set of a based relation.

In some aspects, incremental updates and full refreshes can be dynamically switched from one to the other (e.g., based on a detected data processing latency characteristic or other configuration settings).

In some embodiments, all rows in a DT can be uniquely identifiable by a ROW_ID metadata attribute. The ROW_ID attribute can be used to match changes from the delta set with the rows in the DT or compute delta sets from a DT that is fully refreshed (e.g., depending on the size of the DT, this can be beneficial because it allows for incremental maintenance of downstream views). Hence, each DT can have a ROW_ID metadata column (which corresponds to the metadata columns of tables with enabled change tracking).

Example requirements for the ROW_ID include incremental and at-once computation of the ROW_ID that may yield the same value, and collisions of ROW_IDs may result in data corruption. In some aspects, unique mechanisms may be used if base relations are referenced multiple times (self-join, self-union-all, . . . ). Generation can be insensitive to plan changes (join order, input order, . . . ). In some aspects, runtime validation ROW_IDs can be expensive for production. Still, a debug mode can be added for tests (e.g., full column comparisons for DELETE and UPDATE changes and uniqueness check for INSERT changes can be performed). In some aspects, streams on views can be used to address the ROW_ID requirements.

In some aspects, the following configurations may be used for incremental update maintenance of DTs. Given a delta set (e.g., a set of changes applied to a DT such as an Insert, a Delete, or an Update) for a DT, it can be applied to the DT in two ways:
(a) Single MERGE command. All changes (e.g., encompassed by the delta set) are applied with a single MERGE DML. Updates are processed as upserts (or merges) on the ROW_ID merge key. The following pseudo-code in Table 2 can be used for performing the MERGE command.

```
TABLE 2
MERGE INTO dt m
USING (
  SELECT *, metadata$action, metadata$isupdate, metadata$row_id
  FROM delta_set
  WHERE
  -- upsert on ROW_ID doesn't require the DELETE of an UPDATE change
  NOT (metadata$action = ‘DELETE’ AND metadata$isupdate = TRUE)) AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id
WHEN NOT MATCHED AND metadata$action = ‘INSERT’ AND
metadata$isupdate = FALSE
  THEN INSERT (*, m.metadata$row_id) VALUES (d.*, d.metadata$row_id);
```

(b) A MERGE command followed by an INSERT command. The DELETE and UPDATE changes of the delta set can be applied with a MERGE DML command. The INSERT changes can be applied later with a separate INSERT DML command. The following pseudo-code in Table 3 can be used for performing the MERGE command followed by the INSERT command.

```
TABLE 3
MERGE INTO dt m
USING (
  SELECT *, metadata$action, metadata$isupdate, metadata$row_id
  FROM delta_set
  WHERE
  -- upsert on ROW_ID doesn't require the DELETE of an UPDATE change
  NOT (metadata$action = ‘DELETE’ AND metadata$isupdate = TRUE)
  -- INSERT changes are applied with subsequent INSERT DML
  AND NOT (metadata$action = ‘INSERT’ AND metadata$isupdate = FALSE)
AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id;
INSERT INTO dt(*)
SELECT d.*
FROM delta_set d
WHERE metadata$action = ‘INSERT’ AND metadata$isupdate = FALSE;
```

The above processing can reduce the amount of data to match during a MERGE. The delta set may be persisted to consume from both DMLs.

In some aspects, using ROW_ID as a merge key may create a performance issue (e.g., artificial join keys have a bad locality and can result in inferior performance; an additional merge key may need to be added).

In some aspects, the MERGE, as configured by both approaches, may require a perfect delta set without duplicate keys. However, deduplicating changes to obtain a perfect delta set can be costly. Streams can produce perfect delta sets, and no deduplication is needed. Bitsets may reduce the cost to derive delta sets with duplicates significantly such that they outperform perfect delta sets. In some aspects, the MERGE can be configured to deduplicate merge keys. In some aspects, the delta streams can be used to address redundancies (e.g., an insert and delete with the same row ID and the same values for all columns). More specifically, delta streams can filter out redundancies, and bitsets can reduce the number of such redundancies substantially.

In some aspects, the following configurations may be used for full refresh maintenance. A full refresh set can be computed by evaluating the view definition (enriched by the computation of the ROW_ID attribute) on a consistent version of all base relations. The refresh set can be applied in two ways:
(1) Full replacement: deletes all rows of the DT and inserts all rows of the refresh set. Commands listed in Table 4 can be used for a full replacement.

TABLE 4

DELETE FROM dt;
INSERT INTO dt(*)
SELECT f.*
FROM full_set f;

In some aspects, the ROW_ID ensures that a delta set can be computed from the fully refreshed DT. Depending on the DT size, this processing may be expensive because a full scan and processing of both versions of the DT may be needed.
(2) Merging Changes: compute the differences between both DT versions and evolve the DT into the new version. First, delete all rows that are no longer in the new version, then update all rows that were modified and insert all new rows with a MERGE DML. Commands listed in Table 5 can be used for merging changes.

```
TABLE 5
DELETE FROM dt m
WHERE m.metadata$row_id NOT IN (
SELECT metadata$row_id FROM full_set);
MERGE INTO dt m
USING full_set f
ON m.metadata$row_id = f.metadata$row_id
-- update record
WHEN MATCHED AND m.* <> f.*
  THEN UPDATE SET m.* = d.*, m.metadata$row_id = d.metadata$row_id;
-- insert record
WHEN NOT MATCHED
  THEN INSERT (*, m.metadata$row_id) VALUES (d.*, d.metadata$row_id);
```

In some aspects, merging changes can be more expensive than fully replacing the DT. However, it may be cheaper to extract a delta set from a DT that was updated by merge because fewer records might have been changed. The initial approach to applying full refresh sets can be a full replacement.

In some aspects, delta sets can be persisted as temporary tables. This allows for merging the delta set in multiple steps (e.g., MERGE for UPDATE/DELETE and INSERT), computing and persisting the delta set before the previous delta has been applied on the DT (e.g., defer merging until DT is on the correct version), and scan delta set from the persisted table instead of computing it from DT's history when updating downstream DTs.

After the delta set is merged to its DT and all downstream DTs are updated, the temporary table can be deleted.

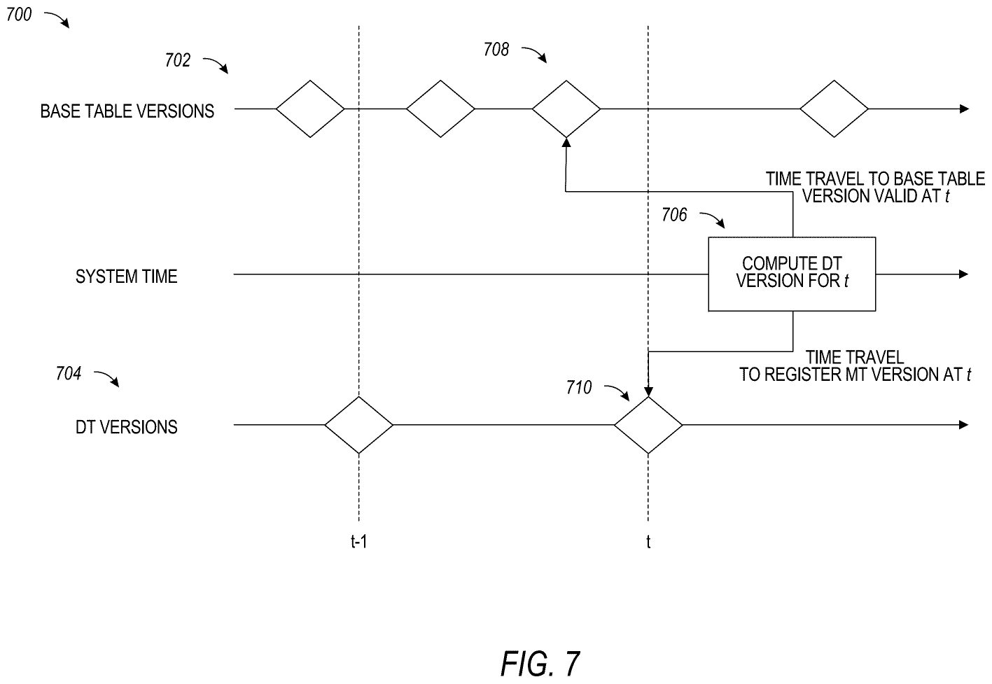

FIG. 7 is diagram 700 illustrating the use of data manipulation language (DML) commands and time travel queries to compute an updated set of a DT with respect to specific versions of its base relations, in accordance with some embodiments of the present disclosure.

In some aspects, the table versions 704 of DTs may be aligned with the base table versions 702 of their corresponding base tables. Using time travel queries (e.g., query 706), the update set of DT 710 may be computed concerning specific versions (e.g., base table 708) of its base relations (e.g., as illustrated in FIG. 7). The new DT version that results from merging the update set in alignment may be registered with the versions of its base relations. Hence, capabilities for the DMLs that update DTs may also be configured. The following describes how to register table versions for DTs and how to look up their versions when they are queried for a specific time.

In some aspects, DML commands that create table versions at a specific time in a DT's base objects' (e.g., base table's) time domain can be configured. The base version time of a new version can be assumed to be after all preceding DT table version base times. Additionally, reads can resolve table versions in this time domain.

In some aspects, streams on DTs can be configured similarly to streams on views (e.g., as discussed in connection with FIGS. 8-12).

FIG. 8 is a diagram 800 of using a CHANGES clause in connection with query processing, in accordance with some embodiments of the present disclosure. Referring to FIG. 8, queries or data processing commands Insert 804, Delete 806, and Update 808 are applied to source table 802. As illustrated in FIG. 8, the SELECT statement 812 may be used for returning the changes that occurred to the source table 802 during period 810 (e.g., one hour).

As used herein, the term “stream” refers to a table and a timestamp. In some aspects, a stream may be used to iterate over changes to a table. When a stream is read inside a Data Manipulation Language (DML) statement, its timestamp may be transactionally advanced to the greater timestamp of its time interval (docs).

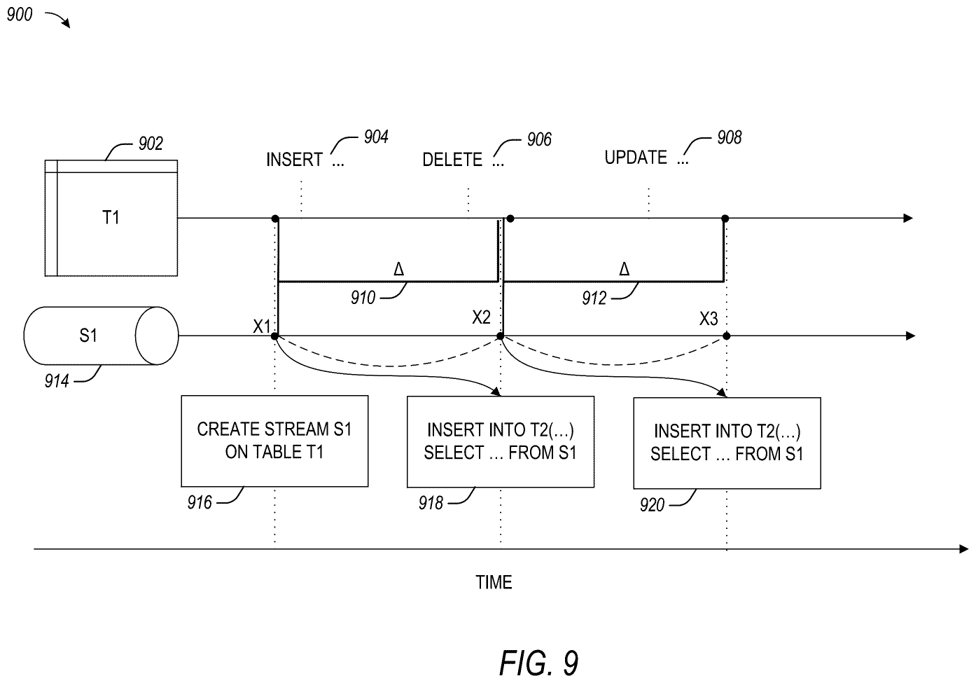

FIG. 9 is diagram 900 of a stream object configuration for a table, in accordance with some embodiments of the present disclosure. Referring to FIG. 9, queries or data processing commands Insert 904, Delete 906, and Update 908 are applied to source table 902. As illustrated in FIG. 9, a stream 914 is generated on source table T1 902 at times X1, X2 (after a time interval of 910 from X1), and X3 (after a time interval of 912 from X2). Additionally, at operation 916, stream S1 is created on table T1. At operation 918, stream SI produces the changes in T1 from time X1 to time X2, which are inserted into table T2. At operation 920, stream S1 produces the changes in T1 from time X2 to time X3, which are inserted into table T2.

As used herein, the term “access control” indicates that customers can control who can access database objects within their organization (docs).

As used herein, the term “data sharing” indicates customers can grant access to database objects to other organizations (docs).

In some aspects, any query with a CHANGES clause or a stream may be referred to as a change query. A change query on a view may be defined similarly.

In some embodiments, the DT manager 128 is configured to provide changes to views (e.g., a stream on views) so that the changes may be further processed and acted on. More specifically, the DT manager 128 may be configured to provide or process streams on views in connection with the following three use cases: shared views, complex views, and view evolution. In some aspects, more than one use case may apply at a given time.

Shared (secure) views may be used to provide (e.g., a user or organization) limited access to sensitive data. The consumer of the data often wishes to observe changes to the data being shared with them. Some considerations implied by this use case include giving the consumer visibility into the shared view's retention period and how to enforce secure view limitations on change queries.

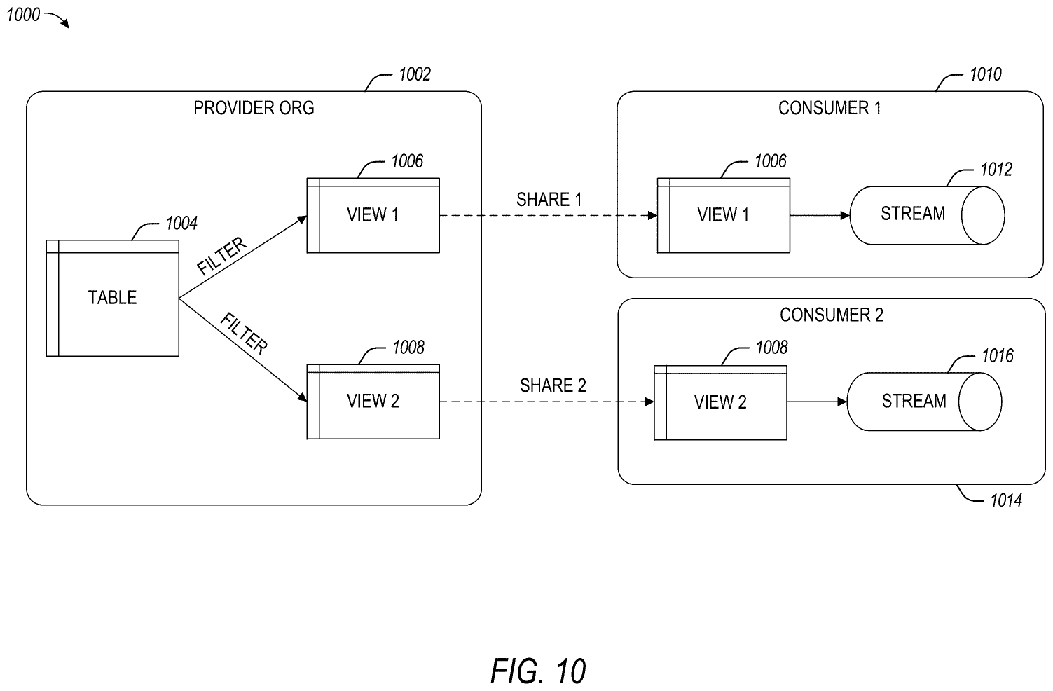

FIG. 10 is a diagram 1000 of shared views, in accordance with some embodiments of the present disclosure. Referring to FIG. 10, a data provider 1002 manages a source table 1004. The data provider 1002 applies different filters to source table 1004 to generate views 1006 and 1008. View 1006 is shared with consumer 1010, and view 1008 is shared with consumer 1014. In some embodiments, the DT manager 128 is used for configuring streams 1012 and 1016 on corresponding views 1006 and 1008 for consumption by consumers 1010 and 1014.

The definition of a view can be quite complex, but observing the changes to such a view may be useful regardless of its complexity. Manually constructing a query to compute those changes may be achieved, but it can be laborious, error-prone, and suffer from performance issues. In some aspects, a change query on a view may automatically rewrite the view query, relieving users of this burden. In some aspects, simple views containing only row-wise operators (e.g., select, project, union all) may be used. In some aspects, complex views that join fact tables with (potentially several) slowly changing dimension (DIM) tables may also be used. Other kinds of operators like aggregates, windowing functions, and recursion may also be used in connection with complex views.

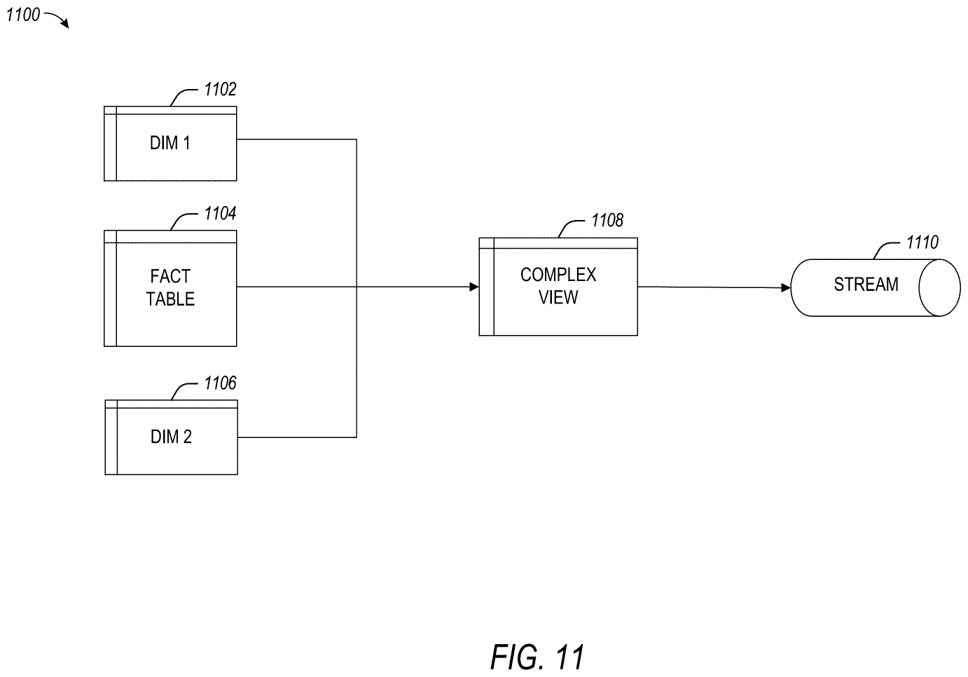

FIG. 11 is diagram 1100 of a stream object based on a complex view, in accordance with some embodiments of the present disclosure. Referring to FIG. 11, a complex view 1108 may be generated based on source tables 1102, 1104, and 1106. In some embodiments, the DT manager 128 configures a stream 1110 based on the complex view 1108 of source tables 1102, 1104, and 1106.

In some aspects, views may be used to create an abstraction boundary, where the underlying tables can be modified without consumers being aware. For example, a view over a table undergoing a backward-incompatible schema change may be replaced by a new query that presents the same data in a different query, causing a view evolution. In some aspects, change queries may work across view redefinition, allowing change observation to the view uninterrupted by modifications to its definition. Considerations for this use case may include schema compatibility and performance. Some view redefinitions may use full joins to resolve, and others, such as workflows involving table clones, could be resolved more efficiently.

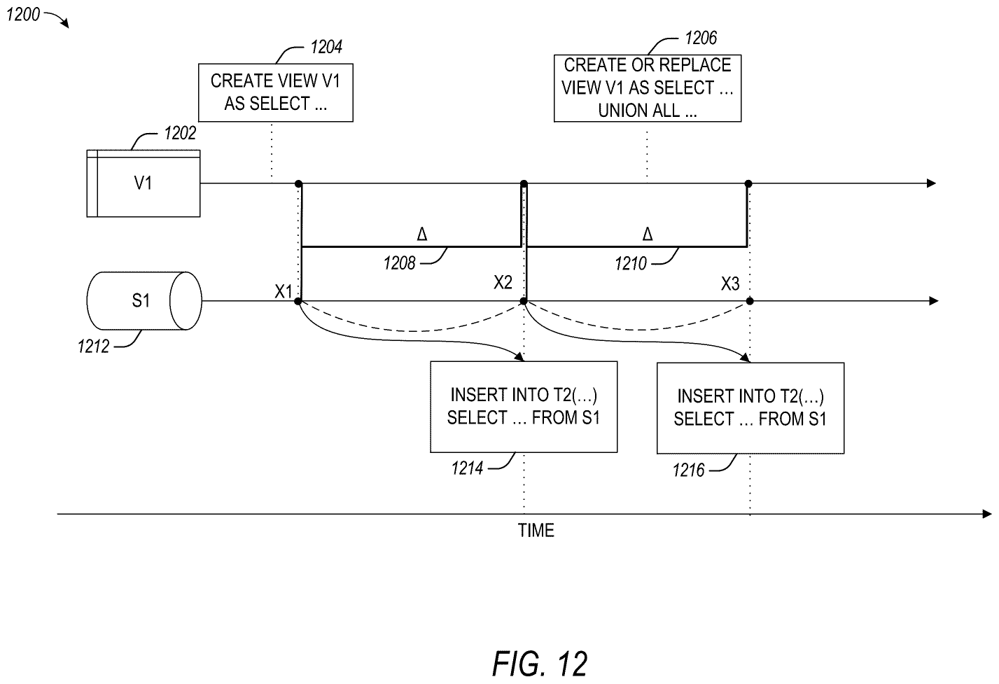

FIG. 12 is diagram 1200 of a view evolution, in accordance with some embodiments of the present disclosure. Referring to FIG. 12, at operation 1204, view V1 1202 is created based on a Select operation. Stream S1 1212 of view V1 1202 is generated at times X1, X2 (after a time interval of 1208 from X1), and X3 (after a time interval of 1210 from X2). Additionally, at operation 1214, a stream entry from stream S1 at time X2 is inserted into table T2. Before time X3, view V1 1202 evolves at operation 1206 when a UNION ALL operation is used. At operation 1216, a stream entry from stream S1 (based on the evolved view V1 at time X3) is inserted into table T2.

In some embodiments, to provide or process streams on views in connection with the above-listed use cases, the DT manager 128 may be configured with the following functionalities: intuitive semantics, unsurprising security, linear cost scaling, and easy operability.

In some aspects associated with intuitive semantics, change queries on views may work intuitively and consistently. The essence of a change query is to take a time-varying object and a time interval, then return a set of changes that explain the differences in the object over the interval. This definition applies naturally to views, but some additional configurations are addressed below.

As not all operations may be supported by the DT manager 128, a property on views may be configured, which explicitly allows change queries on it: CHANGE_TRACKING=true. When a view is created with this property enabled, it is validated that it only contains supported operators, and the base tables have change tracking enabled. When a change query is issued on a view, it may succeed if the view has change tracking enabled.

In some aspects, a standing change query (e.g., a stream) may exhibit reference semantics. That is when a user specifies a view in a change query, such specification may be interpreted as referring to the view itself, not what the view is currently defined as. Adopting value semantics would likely result in surprising behavior, especially around access management.

Adopting reference semantics is associated with the ways a view can be modified. The following techniques may be used for view modifications:
(a) “ALTER VIEW . . . RENAME TO . . . ” When a view is renamed, objects referencing it may be updated. Complying with this precedent means a stream should break if its view is renamed.
(b) “ALTER VIEW. . . . SET SECURE . . . ” If a view is made secure, subsequent change queries to it should enforce secure view constraints.
(c) “CREATE OR REPLACE VIEW . . . ” If a view is replaced, there are processing choices. Per the View Evolution use case, some users may want the view to keep working as long as the replacement is schema-compatible. However, this may add complexity to the implementation.

In some aspects associated with unsurprising security, a consumer of a change query on a view may have the same access they have to the view itself. The following configurations may apply to all views: creating a stream on a view fails if the underlying tables do not have change tracking enabled and the creator does not have permission to enable it; consumers can see the minimum retention period of the tables referenced by a view (they cannot see which table the retention applies to); and if change tracking was enabled on a table in a view more recently than the beginning of the retention period, consumers can see when it was enabled.

In some aspects, the following configurations may be applied to secure views: consumers cannot see the view's definition; consumers cannot issue a change query before access is granted to the view; optimizations abide by secure view limitations (they do not reorder operators into the expanded view), and the retention period on a table in a secure view is not extended automatically to prevent a consuming stream from going stale.

In some aspects associated with linear cost scaling, a key attribute of change queries on tables is that their cost (both in terms of latency and credits) may be proportional to the result size. Append-only change queries may be introduced to work around cases when this scaling does not hold for delta queries. In some aspects, change queries on views may scale similarly in cost. That is, delta change queries and append-only change queries may scale proportionally to the result size.

In some aspects associated with easy operability, introducing change queries on views may increase the likely distance between the view provider and consumer (the shared views use case may revolve around this). The distance makes collaboration between provider and consumer more difficult. In turn, this means that a smooth operational experience for change queries on views is more important than for traditional change queries. In some aspects, the following operational challenges may be addressed by the DT manager 128: handling view modification and surface errors.

In some aspects associated with the handling of view modifications, if the view provider renames or replaces their view, a stream on it will break. The consumer will then want to take action to repair it. The details of such repairs are use case-specific, but it may involve trying to recreate the stream with a new definition and resuming where the broken stream lets off. To support this, the DT manager 128 may be configured to support statements of the following form: CREATE OR REPLACE STREAM s . . . AT (STREAM=>s). The stream S is being both queried and replaced.

In some aspects associated with surface errors, a view consumers may try to issue change queries that are invalid for various reasons. The errors may be surfaced clearly to the consumer. Examples of such errors include: the underlying tables may not have change tracking enabled; the change query may be outside of the tables' retention period; the change query may contain unsupported operators; and the view may have been modified, breaking the change query.

View providers may have control over what happens to a view and any objects derived from it. However, they would benefit from visibility into how the view is being used to avoid accidentally breaking consumers. Examples of such notices include when the provider tries to make a breaking modification to a view, warn the provider that consumers will be disrupted; when consumers' change queries fail due to retention or change tracking, send the provider a notification; and support some introspection as well, such as a view provider looking up the number of streams consuming it and their offsets.

A stream object on tables (including external tables) may be configured to let the user retrieve a stream of changesets as the underlying data in the table changes. A stream object is configured to maintain a position in this list of changesets, and that position is only advanced if it is used in a DML statement. Reading from the stream may return the changeset from the current position up to the current transaction timestamp. As the underlying data changes, the size of the changeset will grow until the stream is advanced. In some aspects, the advance may be transactional.

In some embodiments, the DT manager 128 is configured to create and process stream objects on views, in particular for data-sharing scenarios. In some aspects, shared data consumers may be able to get the latest changes from the shared data provider. Given that exposing shared data is done through secure views, a stream may be created on the consumer side on the view from the provider. In some aspects, streams on materialized views may also be configured to allow retrieving changesets as the underlying MV changes.

In some embodiments, providing changesets on a view (e.g., a query) is similar to the incremental materialized view maintenance problem. In the case of MVs, as the underlying data source(s) change, the materialized data set may be updated incrementally. In some aspects, this processing may be performed at the micro-partition level to create a query plan that uses the data from the added/deleted partitions and merges it with the MV data to produce the updated data.

In the case of a stream object (or stream) on a view, the changeset returned may be the delta of the data the view would return at the current transactional time compared to the data the view would return at the transactional time of the position of the stream. In some aspects, computing the delta efficiently may be a consideration since there may be no materialized data set that can be leveraged and incrementally updated. In some aspects, a materialized view may be created behind the scenes to mitigate this with the limitations of the queries MVs support today, which can make sense, especially for aggregate queries.

In some aspects, the delta for certain classes of queries may be generated efficiently (e.g., if there is only one data source). In that case, the data source of the view can be logically replaced with the delta provided by the stream on the data source. In some embodiments, the DT manager 128 may support projections and filters in the view as well. For example, data processing operators may be allowed where applying the operators on the delta provides the same result as computing the delta on the datasets at the two endpoints. In the initial solution, when the stream is created on a view, support for the view is validated, the data source table is located, and change tracking is set up for the table. When the data is requested from the stream, the underlying view in the query plan is expanded, and the data source table is replaced with generating the delta (similar to the processing applied if a stream on that table is configured in the first place). This processing may also be supported for secure views as well since the data source inside is swapped, and no outside filters would get pushed in.

In addition to maintaining the position of the start point of the change set, the stream may also implicitly expand the retention period on the underlying table up to two weeks depending on how far in the past of the table version history the stream position points. Such processing may also be performed for non-remote data sources. For shared data sources, the same mechanism may not be used because the table compaction status data on the remote side would need to be updated. In this regard, streams on shared data sources can go stale after a day, which is the default retention period for tables. To mitigate this effect, the provider of the shared data can increase the retention period on the table to allow more time for the stream on the provider side to be consumed (and advanced).

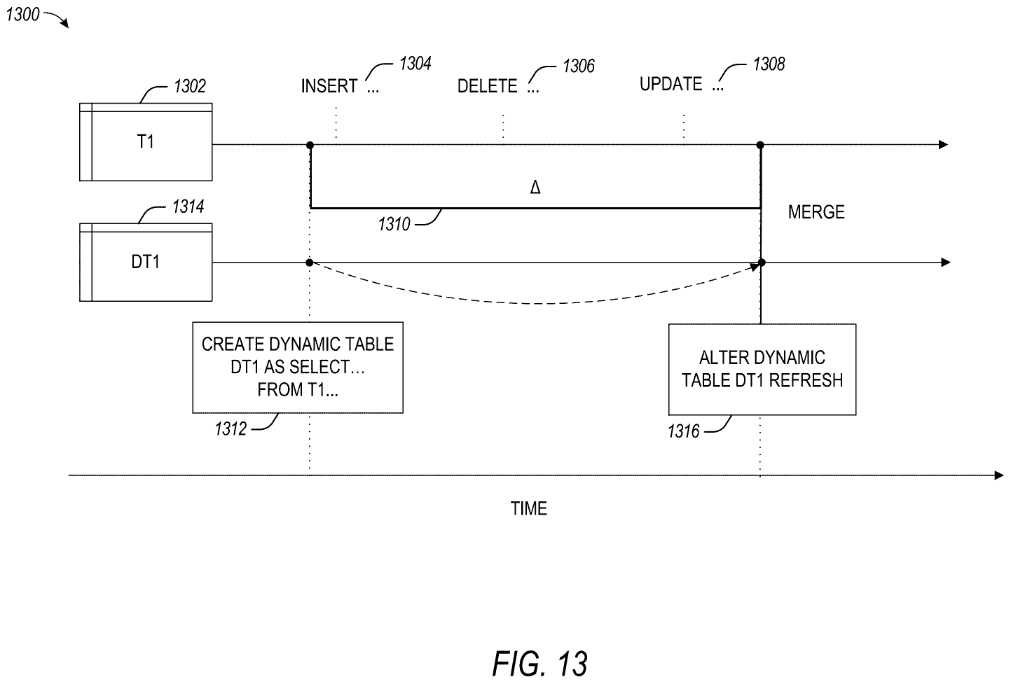

FIG. 13 is diagram 1300 of a dynamic table (DT) refresh, in accordance with some embodiments of the present disclosure. Referring to FIG. 13, at operation 1312, a dynamic table DT1 1314 is created as a select from base table T1 1302. A delta set 1310 can be computed for the base table 1302, which can include data changes based on an Insert operation 1304, a Delete operation 1306, and an Update operation 1308 applied to base table 1302. A refresh operation 1316 can be performed on DT1 1314 by merging the delta set 1310 with DT1 1314.

In some aspects, an incremental refresh of DTs can be configured using the configurations and techniques discussed herein. An incremental refresh can be a more optimal function in place of computing a DT's state every time a refresh is needed. During an incremental refresh, data is considered from the last time query results are computed, the difference between the query results and a new value is determined, and the determined change (or difference) is applied on top of the previous result.

The disclosed incremental refresh configurations can be used to handle several interdependent scenarios, which can make it challenging to partition into independent pieces. The scenarios are:
(a) Nested DTs: One DT queries another DT, and changes to one must be incrementally propagated to the other.
(b) Composite DTs: a single DT contains a sufficiently complex query that needs to be split into two or more DTs containing an intermediate state. A simple example of this scenario is COUNT (DISTINCT*).
(c) Query Facades: When querying a DT, the query plan may need to apply additional operations atop the intermediate state to compute the correct result. An example of this is AVG (_), which can be stored as SUM (_) and COUNT( ) separately and then produced as the quotient.

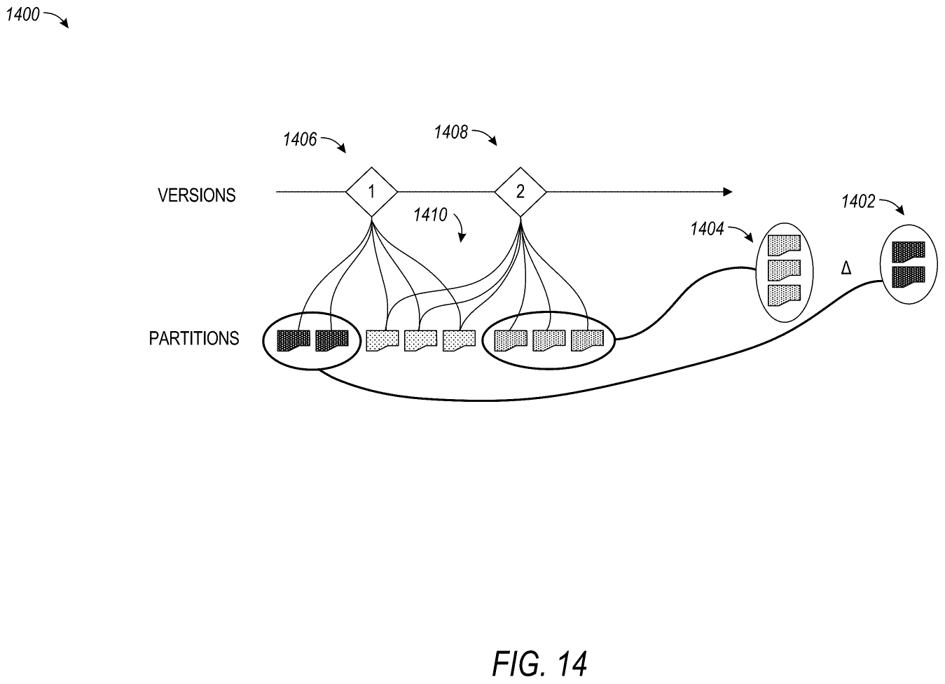

FIG. 14 is a diagram 1400 illustrating the determination of changes (or delta (A) or delta set) to a base table for a DT refresh, in accordance with some embodiments of the present disclosure. Referring to FIG. 14, a base table can be associated with versions 1406 and 1408 (also referenced as 1 and 2 in FIG. 14). To determine the delta set, the deleted files 1402 are determined, and the new (added) files 1404 are determined. The common files 1410 can be ignored for purposes of delta set determination. The delta set is the symmetric set difference of the rows in the deleted files 1402 and the rows in the added files 1404.

In some aspects, DT manager 128 can configure managed dynamic Iceberg tables based on the disclosed configurations.

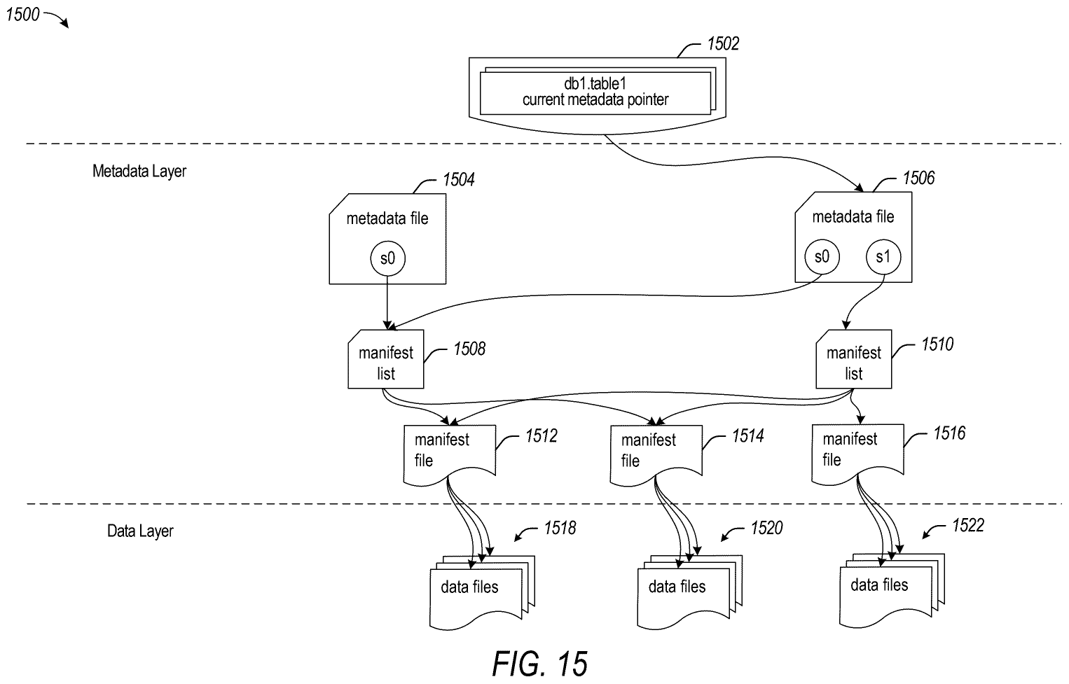

FIG. 15 is a block diagram 1500 illustrating files defining an Iceberg table, which can be used in connection with the present disclosure. Referring to FIG. 15, data files 1518, 1520, and 1522 (of the data layer) may be in any format, including Parquet format. The metadata layer for the Iceberg specification includes metadata files 1504 and 1506 that list different snapshots (e.g., s0 and s1, as illustrated in FIG. 15) of the table. Each snapshot can point to a corresponding manifest list (e.g., manifest lists 1508 and 1510) containing the relevant manifest files (e.g., manifest files 1512, 1514, and 1516). Each of the manifest files points to the final data files. The current metadata pointer 1502 for a table can be implemented differently for each system.

DT manager 128 can use the disclosed configurations to configure managed dynamic Iceberg tables and dynamic tables, which consume from Iceberg base tables.

In some aspects, a managed Iceberg table can include an Iceberg table catalog and manifest files managed by an NBDS.

In some aspects, the managed dynamic Iceberg table includes a dynamic table that stores its content in Iceberg.

In some aspects, dynamic tables on Iceberg include dynamic non-Iceberg tables, which consume from managed Iceberg base tables.

In some aspects, DT manager 128 can configure a managed dynamic Iceberg table based on the following syntax (or configuration) listed in Table 6 below.

TABLE 6

CREATE DYNAMIC ICEBERG TABLE <name>
TARGET_LAG = <lag>
WAREHOUSE = <warehouse>
[CATALOG = ‘NBDS’]
EXTERNAL_VOLUME = <external_volume_name>
BASE_LOCATION = <relative_path_from_external_volume>

In the above syntax, the CATALOG value indicates an entity (e.g., NBDS 102) that manages the metadata layer and the data layer of the Iceberg table. The EXTERNAL_VOLUME indicates a storage location (an external volume) where the Iceberg table files will be stored. The BASE LOCATION indicates a link (or path) in the external volume of a specific location/area in the external storage where the Iceberg table files are stored.

In some aspects, CATALOG is an account/database/schema/table parameter that the customer can set. Dynamic Iceberg tables will validate that the catalog value is NBDS (e.g., NBDS 102) and throw an appropriate error if the catalog is missing or not NBDS.

In some aspects, the DT manager 128 can use dynamic Iceberg table abstractions, which can blend the required Iceberg and dynamic table behavior.

In some aspects, the new dynamic Iceberg table classes/interfaces can override any methods to support NBDS-managed Iceberg tables exclusively.

In some aspects, creating dynamic tables can use the SqlCreateIcebergTable node in the SqlParser which handles the validation of and setup of required iceberg properties with minor changes to enforce specific dynamic Iceberg table requirements.

In some aspects, dynamic Iceberg tables can have the “isIceberg” flag set to TRUE and IcebergTableType.MANAGED, which allows differentiating between Iceberg and non-Iceberg DTs across compiler components.

In some aspects, the code in the parser and compiler can rely on the target domain, the target “isIceberg” property, the target IcebergTableType, and various “isIcebergTable” helper methods to determine if Iceberg-specific logic needs to be executed.

In some aspects, dynamic Iceberg tables will have isIceberg=TRUE and IcebergTableType.MANAGED, which satisfies most code branches. However, there are several components that may be modified to support both Iceberg tables and dynamic Iceberg tables. In some aspects, the IcebergCommandValidator and various methods within the parsing path can rely on Domain.ICEBERG_TABLE. In some aspects, branches can be updated to support dynamic Iceberg tables as needed.

In some aspects, if (getDomain( )==Domain.ICEBERG_TABLE) becomes if (getDomain( )==Domain.ICEBERG_TABLE∥ isDynamicIcebergTable( )).

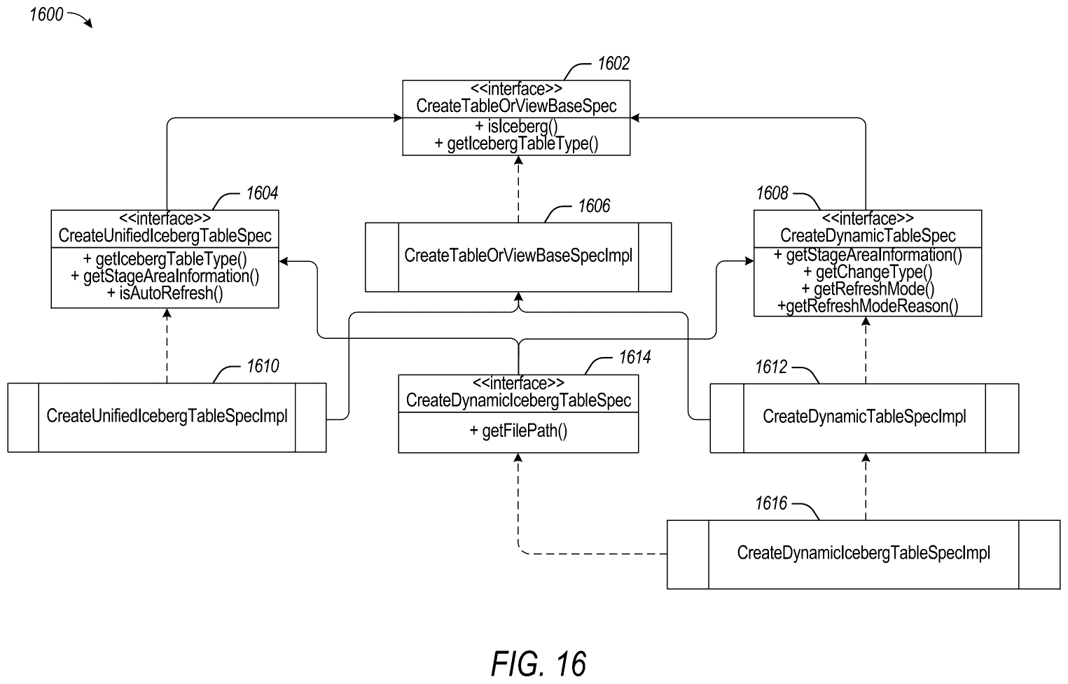

FIG. 16 is a diagram 1600 illustrating table specifications associated with dynamic tables, including managed dynamic Iceberg tables, in accordance with some embodiments of the present disclosure.

Referring to FIG. 16, a create table/view specification 1602 can be based on create Iceberg table specification 1604 and create dynamic table specification 1608. The create table/view specification 1602 can be implemented or activated by using the create table/view specification implementation function 1606. Similarly, create Iceberg table specification 1604 and create dynamic table specification 1608 can be implemented or activated by corresponding create Iceberg table specification implementation function 1610 and create dynamic table specification implementation function 1612.

The create Iceberg table specification 1604 can include the following metadata fields: table type (e.g., managed by the NBDS 102 or unmanaged), stage area information (e.g., information needed to access the files in the designated stage area), and an indication on whether the Iceberg table should be auto-refreshed.

The create dynamic table specification 1608 can include the following metadata fields: stage area information (e.g., the information needed to access the files in a designated stage area), change type (e.g., incremental refresh or full refresh), refresh mode (e.g., when to perform a refresh, such as on-create refresh, on-schedule refresh, and automatic refresh), and refresh mode reason.

In some aspects, a create dynamic Iceberg table specification 1614 is configured, which includes an interface to (e.g., uses both or is a union of) create Iceberg table specification 1604 and create dynamic table specification 1608. The create dynamic Iceberg table specification 1614 can be implemented or activated by using the create dynamic Iceberg table specification implementation function 1616. In some aspects, the create dynamic Iceberg table specification 1614 includes the metadata field getFilePath, which is the base location specified in the managed dynamic Iceberg table syntax. In addition, the create dynamic Iceberg table specification 1614 also includes the metadata of both the create Iceberg table specification 1604 and the create dynamic table specification 1608.

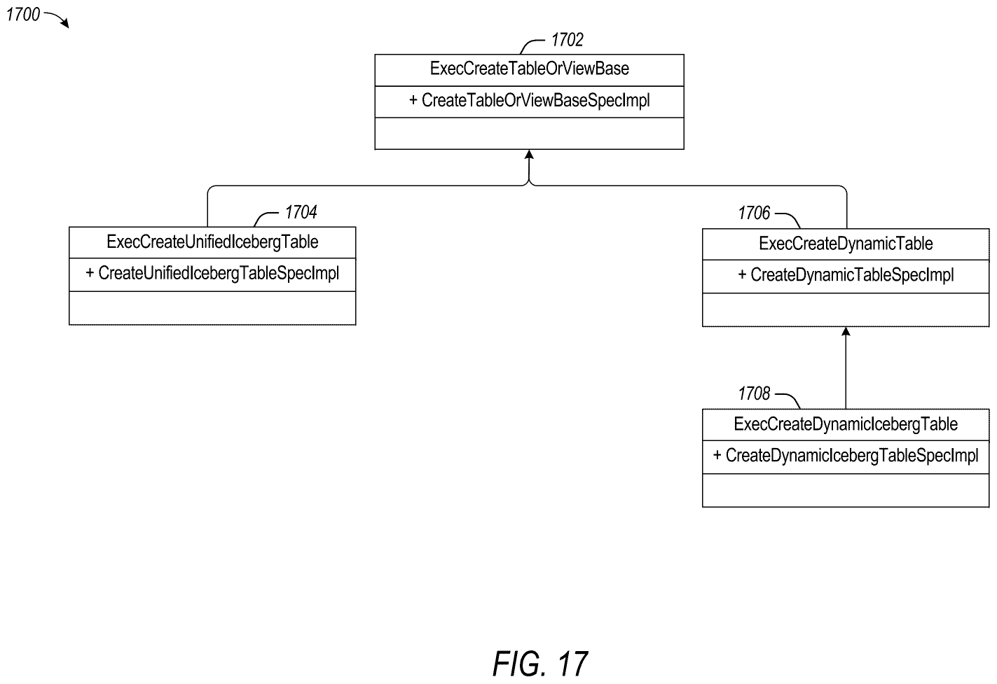

FIG. 17 is a diagram 1700 of compute nodes that can be used to instantiate the creation of different types of tables, including a managed dynamic Iceberg table, in accordance with some embodiments of the present disclosure. Referring to FIG. 17, node 1702 can be used to instantiate the creation of a new table or view (e.g., based on the create table/view specification 1602). Similarly, node 1704 can be used to instantiate the creation of a new Iceberg table (e.g., based on the create dynamic Iceberg table specification 1614), node 1706 can be used to instantiate the creation of a new table or view (e.g., based on the create dynamic table specification 1608), and node 1708 can be used to instantiate the creation of a managed dynamic Iceberg table (e.g., based on the create dynamic Iceberg table specification 1614).

Table 7 below lists an example pseudo-code for configuring the managed dynamic Iceberg table specification (e.g., create dynamic Iceberg table specification 1614) and the execution node (e.g., node 1708) for instantiating the specification.

TABLE 7

```
Java
ExecCreate Diagram
public interface CreateDynamicIcebergTableSpec extends
CreateDynamicTableSpec,
CreateUnifiedIcebergTableSpec {
    String getFilePath( );
}
  public class ExecCreateDynamicIcebergTable extends
  ExecCreateDynamicTable
{
    private final filePath;
    ...
    private static class CreateDynamicIcebergTableSpecImpl
      extends CreateDynamicTableSpecImpl implements
CreateDynamicIcebergTableSpec {
    ...
    ...
    @Override
    public boolean isAutoRefresh( ) { return false; }
    @Override
    public boolean isIceberg( ) { return true; }
    @Override
    public String getFilePath( ) { return this.filePath; }
    @Override
    public IcebergTableType getIcebergTableType( ) {
        return IcebergTableType.MANAGED;
    }
  }
  @Override
    public IcebergTableType getIcebergTableType( ) {
    return IcebergTableType.MANAGED;
    }
}
```

In some aspects, an existing dynamic table can be overloaded with required Iceberg information. This approach can be similar to the approach above; however, required Iceberg information can be included in the existing Dynamic Table abstractions.

In some aspects. DT manager 128 can create a clone from an Iceberg table.

In some aspects, dynamic tables that consume from Iceberg base tables can be replicated. In some aspects, the Iceberg base tables can be skipped, resulting in a dangling reference/broken state on the secondary.

In some aspects, managed and unmanaged Iceberg tables can support replication. Replication refresh jobs can skip these objects and do not cause refresh failures. In some aspects, managed dynamic Iceberg tables can extend this behavior.

In some aspects, dynamic and Iceberg tables can be integrated well, but the differences between Iceberg and regular database tables can introduce challenges. Storing dynamic table data as a managed Iceberg table can be configured by the DT manager. In some aspects, challenges can arise from querying Iceberg tables from the definition of a dynamic table. These challenges can be overcome, first by providing incremental refreshes for managed Iceberg tables and then by handling unmanaged Iceberg tables and external DMLs.

Dynamic tables are a feature that allows the definition of data pipelines declaratively in terms of SELECT queries. The NBDS can manage orchestrating refreshes on behalf of the user and refreshing the tables incrementally. Supporting incremental refresh can impose the following requirements:
(a) Access to deleted rows. In order to propagate the effects of deletions from sources, a dynamic table needs to be able to read data that was deleted from prior versions of the source.
(b) Support for change tracking columns. Incremental refresh uses a set of internal columns called change-tracking columns to efficiently compute the changes between versions of a table. For database tables, these columns are maintained automatically as part of every DML operation. For tables that are changed by engines other than the NBDS, these columns are not maintained and cannot be relied upon.
(c) Support for change-tracking bitsets.

Apache Iceberg is an OSS “table format” that allows data engineers to manage table-like datasets stored in Parquet files on blob storage. NBDS-managed Iceberg tables bring the governance and querying capabilities of the NBDS to Iceberg tables. They can be one of the following 3 kinds:
(a) Unmanaged “Loose Parquet” tables.

The contents of the table are defined by the files in an object storage bucket. This means the only way to delete data from such a table is to delete the file from object storage, rendering it inaccessible to queries.

These tables are read-only and may not support any change-tracking information.

Most use cases involving “loose Parquet” are insert-only and do not perform copy-on-write operations.
(b) Unmanaged Iceberg tables.

The contents of the table are defined by an Apache Iceberg snapshot stored in object storage alongside the data. These manifests are periodically imported into the NBDS. Several versions of the table can coexist, and thus, access to deleted rows is typical. However, there are no guarantees about the retention of old versions.

In some aspects, these tables are read-only and may not support change-tracking information.

In some aspects, users of these tables perform copy-on-write (more common) and merge-on-read (less common) DMLs on these tables (docs). Merge-on-read relies on “row level deletes,” which are similar conceptually to change-tracking bitsets.
(c) Managed Iceberg tables.

In some aspects, the NBDS is the source of truth for the contents of the table and periodically exports manifest files to object storage.

In some aspects, these tables support DML operations by the NBDS, which can maintain change-tracking columns.

In some aspects, external DMLs can be supported on these tables, whereby another engine performs a DML to create a new Iceberg snapshot and then applies the changes implied by that snapshot to the managed Iceberg table. Such DML may not maintain change-tracking columns or change-tracking bitsets.

In some aspects, DT manager 128 can use the following two techniques to integrate dynamic and Iceberg tables.
(a) Dynamic tables stored as Iceberg tables. This can work for managed Iceberg tables without external DMLs and does not present implementation challenges.
(b) Dynamic tables reading from Iceberg tables.

The challenge to querying Iceberg tables from dynamic tables comes down to the tension between DT requirements and the metadata available in Iceberg tables. Incremental refresh of a dynamic table can be based on the following configurations.
(b.1) Access to removed files for a predictable amount of time before they are deleted. In some aspects, managed Iceberg tables can provide this functionality.
(b.2) Change tracking metadata to be maintained by DMLs.

In some aspects, DT manager 128 can support incremental refreshes on managed Iceberg tables without external DMLs by adding support for change tracking.

In some aspects, DT manager 128 can support incremental refresh on any Iceberg or external Tables by using a new refresh mode and restricting to file-preserving queries.

For a subset of queries, dynamic tables can implement a refresh mode that is oriented around files. This is the approach MVs take. In some aspects, each row in the DT would keep track of the name of the file from which it originated. If files are added to or removed from an Iceberg table, the DT manager can delete all affected rows from dependent dynamic tables and insert new rows for the added files. This can work for queries where each output row originates from a single file, which roughly corresponds to filters, projections, UNION-ALLs, and a single level of GROUP-BY. Some limited support for JOINs may be provided.

In some aspects, DT manager 128 can support insert-only refresh on any Iceberg or external tables by introducing insert-only constraints and restricting to monotonic queries. Many use cases require keeping track of inserts. In the absence of deletes, neither change-tracking metadata nor access to deleted files is required. These use cases can be unlocked by introducing the concept of finalization to let users indicate that a dataset should be treated as insert-only. Then, any monotonic query (i.e., one that, given insert-only inputs, produces insert-only outputs) can be incrementally maintained as a dynamic table. This incremental maintenance would be very efficient because it never has to delete data. The caveat here is that a copy-on-write operation on an insert-only source would result in duplicates from the copied rows.

In some aspects, dynamic tables' incremental refresh relies on change_tracking on the underlying tables. Change_tracking identifies rows by their MD$ROWID, which is composed of a file identifier and a row identifier in the file. The following configurations can be associated with the file identifier:
(a) May not contain sensitive information. The field externalFileId can be used as MD$PRIMARY_PARTITION_NAME.
(b) Can be globally unique (e.g., replication-based).
(c) Can be immutable and tied to the file (e.g., replication-based).
(d) Can be configured for backfill (transition from unmanaged to managed Iceberg tables can be performed).

In some aspects, externalFileId can be used as MD$PRIMARY_PARTITION_NAME.

Change_tracking identifies rows by their MD$ROWID. If the row is newly added to a partition, MD$ROWID=hash (MD$PRIMARY_PARTITION_NAME, MD$PRIMARY_PARTITION_ROW_NUMBER).

If the row is moved to a new partition as a result of a DML, MD$ROWID=hash (MD$ORIGINAL_PARTITION_NAME, MD$ORIGINAL_PARTITION_ROW_NUMBER).

In a regular NBDS table, the MD$PRIMARY_PARTITION_NAME is the shortName, which contains sensitive information (e.g., account_id, deplyoment_id). When change_tracking is enabled on Iceberg tables, externalFileIds can be used as PRIMARY_PARTITION_NAME to prevent leaking sensitive information.

In some aspects, ORIGINAL_PARTITION_NAME is the PRIMARY_PARTITION_NAME of the file that first contained the row and is a persisted column populated by scanbacks.

In some aspects, full names on Iceberg tables can be globally unique. This can be a shared requirement with PRIMARY_PARTITION_NAME (a requirement for replication), and the same value can be used for the two.

In some aspects, the FILE_FULL_NAME pseudo-column can be used as the PRIMARY_PARTITION_NAME for Iceberg tables.

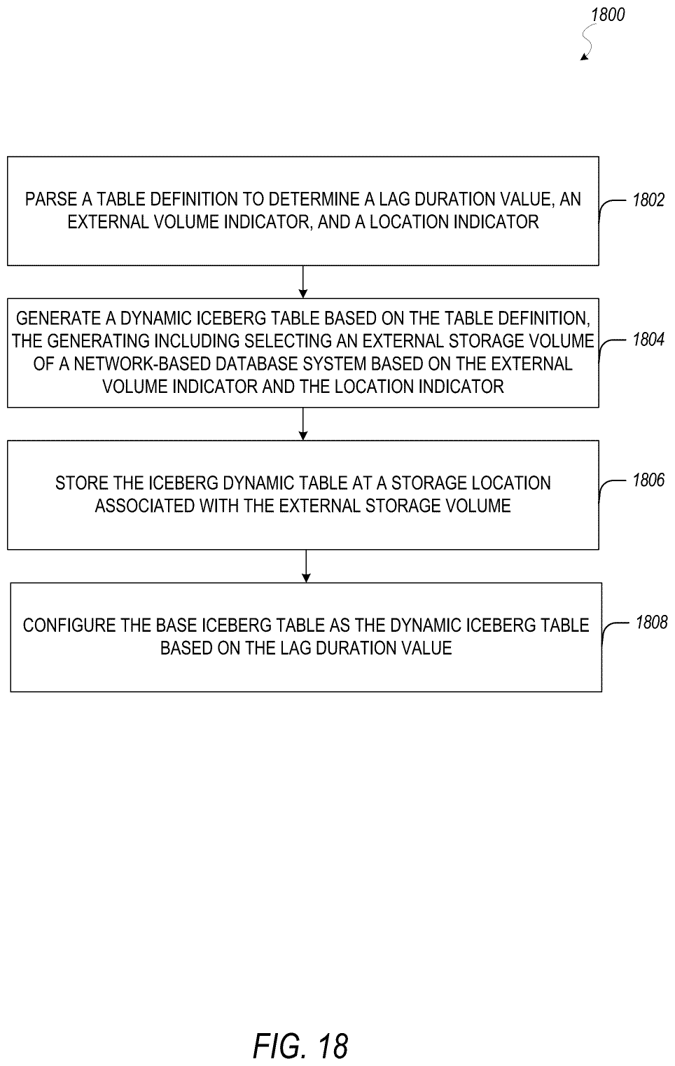

FIG. 18 is a flow diagram illustrating the operations of a database system in performing method 1800 for configuring managed dynamic Iceberg tables, in accordance with some embodiments of the present disclosure. Method 1800 may be embodied in computer-readable instructions for execution by one or more hardware components (e.g., one or more processors) such that the operations of method 1800 may be performed by components of NBDS 102, such as components of the compute service manager 108 (e.g., the DT manager 128) and/or the execution platform 110 (which components may be implemented as machine 2600 of FIG. 26). Accordingly, method 1800 is described below, by way of example with reference thereto. However, method 1800 may be deployed on various other hardware configurations and is not intended to be limited to deployment within the NBDS 102.

At operation 1802, the DT manager 128 can parse a table definition to determine a lag duration value, an external volume indicator, and a location indicator (e.g., as illustrated in Table 6).

At operation 1804, the DT manager 128 generates a dynamic Iceberg table based on the table definition. The generating includes selecting an external storage volume of an NBDS (e.g., NBDS 102) based on the external volume indicator and the location indicator.

At operation 1806, the DT manager 128 stores a base Iceberg table at a storage location associated with the external storage volume.

At operation 1808, the DT manager 128 configures the base Iceberg table as the dynamic Iceberg table based on the lag duration value. The lag duration value indicates a maximum time period that a result of a prior refresh of the dynamic Iceberg table lags behind a current time instance.

Dynamic tables are increasingly used in modern data platforms to automate and optimize the process of maintaining up-to-date query results as underlying data changes. When these dynamic tables are configured to consume data from externally managed sources, such as unmanaged Apache Iceberg tables, the absence of persistent row-level identifiers and internal change tracking columns introduces significant complexity in detecting and processing incremental changes. To overcome these limitations, the present disclosure further introduces a set of techniques that enable dynamic tables to efficiently track and apply only the actual data changes between table versions, even when the source tables do not natively support change tracking. These techniques utilize deterministic row identifier generation based on immutable metadata, as well as mechanisms for interpreting partition registration and unregistration events to infer row-level modifications. FIGS. 19-25 provide detailed visualizations of these processes, including the computation and reduction of row-level changes, the use of partition metadata for change inference, and the propagation of incremental updates through dynamic tables. These figures collectively illustrate the application of the disclosed techniques in supporting robust and efficient incremental refreshes for dynamic tables sourcing from Iceberg tables.

In some aspects, the DT manager 128 can implement a copy-blind change tracking approach that does not use change-tracking columns. The DT manager 128 derives ROW_IDs from the row's filename, position within the file, and the Iceberg TableUUID. This approach enables change tracking without relying on internal change tracking columns that may not be available in externally managed tables. In some aspects, DT manager 128 can be configured to perform copy-blind change tracking for incremental refreshes in dynamic tables, particularly when working with externally managed source tables.

Dynamic tables rely on internal change tracking columns to maintain the position of each row from the moment it is inserted into a table. When a row is copied due to a data manipulation operation, its position metadata is preserved, resulting in a persistent identity for each row. This identity is represented by the METADATA$ROW_ID, which is a unique and immutable identifier. For fully managed tables, the ROW_ID can be computed by hashing the original partition name and the row number within that partition. This mechanism ensures that each row can be uniquely and persistently identified across table versions.

In some aspects, the DT manager 128 can maintain a row version metadata column that tracks when the actual content of a row changes, distinct from row movement between files. The DT manager 128 can increment the row version only when a row's actual content changes, while preserving the row version intact when a row moves to a different file without content changes. This row version facilitates identification during change computation of whether a row has actually changed versus merely migrated to a new file location.

In some aspects, the DT manager 128 can perform a change consolidation process that identifies which rows were inserted, deleted, or updated. The DT manager 128 can exclude rows that are strictly copied from the change set, reducing unnecessary processing. This consolidation step processes the sets of inserted and deleted rows to determine the net changes that need propagation.

In some aspects, incremental refreshes depend on the ROW_ID to determine which rows have changed since the last update. In some aspects, the row ID (e.g., METADATA$ROW_ID) can be configured as a unique and persistent identifier for each row, immutable and linked to the file, free of sensitive information, and globally unique to support replication scenarios.

In some aspects, DT manager 128 can use change reduction as an optimization that leverages the persistent ROW_ID to prevent write amplification in copy-on-write source tables. The process can include scanning added and removed files, treating rows from removed files as deletes (assigned a value of −1) and rows from added files as inserts (assigned a value of 1). By grouping rows according to their ROW_ID and user-defined columns and summing their values (e.g., as can be configured based on the disclosed techniques), the DT manager 128 can identify and eliminate rows that have not been modified (e.g., those with a sum of zero). This configuration can be used to reduce the number of rows that need to be propagated through the query plan, improving the efficiency of incremental refreshes.

FIG. 19 is a diagram 1900 illustrating the computation and reduction of row-level changes between two table versions (e.g., table 1902 and table 1904), in accordance with some embodiments of the present disclosure. This figure is related to the incremental refresh and change reduction processes described in connection with FIG. 14, which addresses the determination of changes (delta sets) to a base table for a dynamic table refresh, and is further relevant to the dynamic table update and merge operations discussed in FIG. 13.

In FIG. 19, step A shows Table Version 1 (table 1902) and Table Version 2 (table 1904), each containing rows identified by a “ROW” column and associated “COL” values. TableVersion 1 includes rows A, B, and C with values 1, 2, and 3, respectively, while Table Version 2 reflects an update to row A (now with value 10) and unchanged rows B and C.

Step B presents a delta table 1906 (e.g., table 1906), where changes between the two versions are computed. Each entry in the delta table 1906 includes an “ACTION” (DELETE or INSERT), the “ROW” identifier, the “COL” value, and a “VALUE” indicating the type of change (−1 for DELETE, 1 for INSERT). For example, rows from Table Version 1 are marked as DELETE, and rows from Table Version 2 are marked as INSERT.

Step C shows the consolidation of the delta table 1906 into a summarized table 1908. Here, rows are grouped by their ROW and COL values, and the VALUE column is aggregated. The resulting SUM (VALUE) column indicates the net effect: a value of −1 for deletion, 1 for insertion, and 0 for unchanged rows.

Step D further reduces the summarized table 1908 to the final change set 1910 by excluding rows with a SUM (VALUE) of 0, thus propagating only the net changes. The final change set 1910 includes only the removal of row A with value 1 and the insertion of row A with value 10.

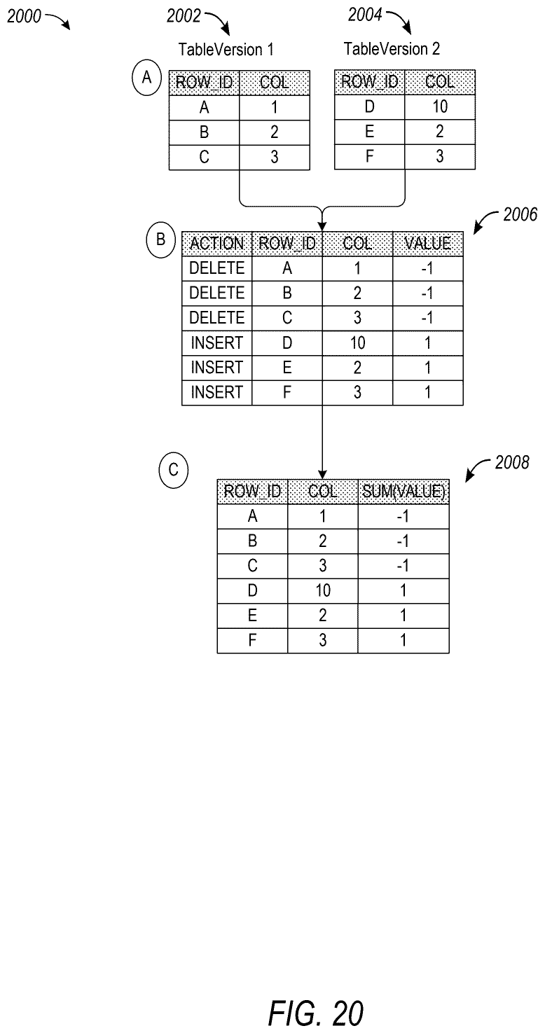

FIG. 20 illustrates a block diagram of an example row-action and value-aggregation process 2000 for table versions with non-overlapping row sets, in accordance with some examples of the present disclosure. This figure illustrates an example processing scenario of unmanaged Iceberg table copy-on-write amplification, as described below. In unmanaged Iceberg tables, query engines may not support change tracking columns, so there are no persistent ROW_IDs across table versions. When a row in an unmanaged Iceberg table is modified, an entirely new partition is written, and each row within this new partition is assigned a new ROW_ID, even if it was copied from the preceding partition. This lack of persistent ROW_IDs prohibits effective change reduction because grouping by ROW_ID will never exclude redundant insert/delete pairs.

In section A of FIG. 20, Table Version 1 (table 2002) and Table Version 2 (table 2004) are shown, each containing rows identified by their respective row identifiers (ROW) and associated column values (COL). TableVersion 1 includes rows A, B, and C with column values 1, 2, and 3, respectively, while Table Version 2 includes rows D, E, and F with column values 10, 2, and 3, respectively. Since the query engine does not support change tracking columns, the ROW_IDs from Table Version 1 differ from the recomputed ROW_IDs in Table Version 2, even though only a single row was modified.

Section B of FIG. 20 presents the delta table 2006, which the DT manager 128 can generate by scanning both parquet files. Table Version 1 is a removed file, so its rows are marked as DELETE and assigned a value of −1. Table Version 2 is an added file, so its rows are marked as INSERT and assigned a value of 1.

Section C of FIG. 20 shows the consolidated table 2008, where entries are grouped by ROW and COL values, and the VALUE column is aggregated to produce SUM(VALUE). In this case, all rows from Table Version 1 2002 have SUM (VALUE) of −1, indicating deletion, and all rows from Table Version 2 2004 have SUM(VALUE) of 1, indicating insertion. Because the ROW_IDs are not persistent, even though only a single row was modified, the DT manager 128 may not be able to eliminate any rows from the change set, resulting in unnecessary propagation of insert and delete operations for unchanged rows.

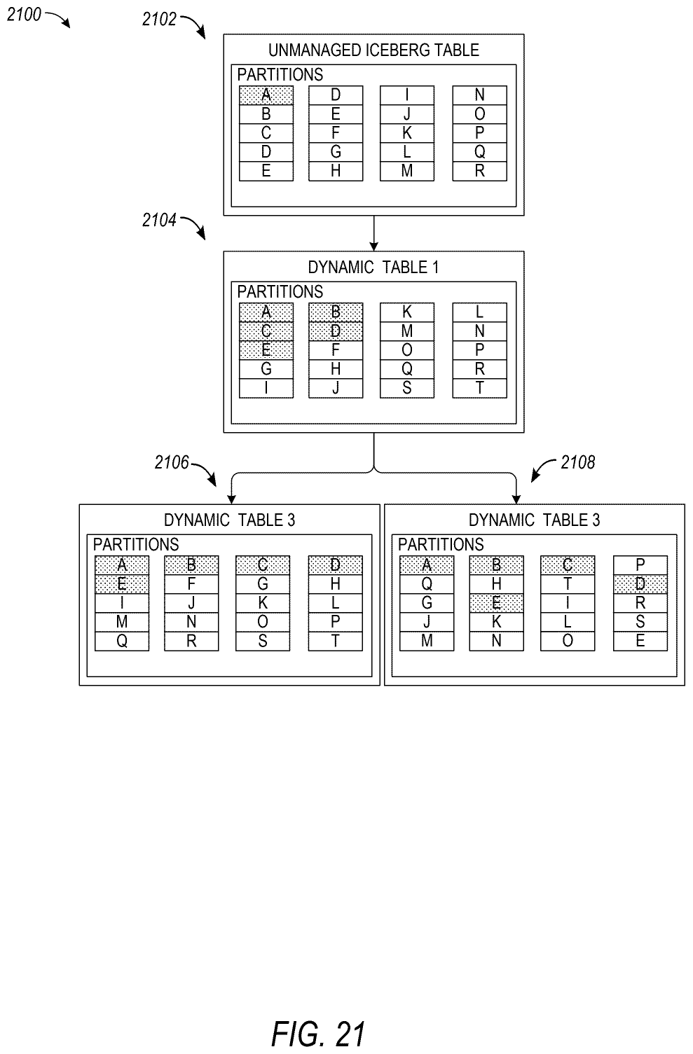

FIG. 21 is a diagram 2100 illustrating the relationship between an unmanaged Iceberg table and multiple dynamic tables consuming its partitions, in accordance with some embodiments of the present disclosure. More specifically, FIG. 21 illustrates the effect of the absence of change reduction in unmanaged Iceberg tables, focusing on the resulting write amplification across data pipelines, in accordance with some examples of the present disclosure. The figure depicts an unmanaged Iceberg table 2102 with four partitions, where an update operation is performed that only modifies the row with the value “A” (highlighted in a dotted pattern). Despite the fact that only a single row is changed, the update causes the entire partition containing “A” to be rewritten. As a result, new ROW_IDs are generated not only for the modified row “A” but also for all other rows in the same partition, including unchanged rows {B, C, D, E}. Consequently, the computed delta for the update is Δ= {A, B, C, D, E} instead of the expected Δ={A}. This means that unchanged rows are treated as new or deleted in downstream processing, leading to unnecessary insert and delete operations for these rows in all consuming dynamic tables and pipelines.

FIG. 21 further shows how these changes propagate through a pipeline of dynamic tables. The unmanaged Iceberg table 2102 serves as the source for a first dynamic table DT 2104, which in turn feeds into additional dynamic tables DT 2106 and DT 2108. Because new ROW_IDs are assigned to all rows in the rewritten partition, unchanged rows {B, C, D, E} are unnecessarily processed and written in each downstream dynamic table, compounding the write amplification effect. The problem is further exacerbated by the large size of Parquet files, which increases the volume of redundant data movement and processing. FIG. 21 thus demonstrates how the lack of persistent row identifiers and change reduction mechanisms in unmanaged Iceberg tables can significantly increase resource consumption and reduce the efficiency of data workflows across multiple dynamic tables.

In some aspects, for DTs with unmanaged Iceberg table sources, the DT manager 128 can derive the ROW-ID from the row's filename and its position within the file. This approach is necessary because unmanaged Iceberg table metadata does not provide change tracking columns or a way to uniquely identify copy-on-write rows.

In some aspects, the ROW_ID can be computed as follows:

METADATA$ROW_ID=

CONCAT (METADATA$FILENAME,‘:’,BASE_64(SHA_1 (CONCAT(METADAT A$FILENAME,‘$’,METADATA$PARTITION_ROW_NUMBER))>>1).

In some aspects, the DT manager 128 can incorporate the Iceberg TableUUID into the ROW\_ID computation in addition to filename and position. The DT manager 128 incorporates the TableUUID to ensure global uniqueness of row identifiers across different tables and prevent collisions when multiple tables contain files with similar names or structures.

In some aspects, METADATA$FILENAME is configured as a metadata column that refers to the file path in storage. For unmanaged Iceberg tables, this is the file path to the parquet file.

In some aspects, METADATA$PARTITION_ROW_NUMBER is configured as a metadata column that refers to the row number within a partition. For unmanaged Iceberg tables, this is the row ordinal within the parquet file.

In some aspects, the disclosed techniques include concatenating METADATA$FILENAME and METADATA$PARTITION_ROW_NUMBER with a $ delimiter. The ‘$’ delimiter can be used to separate FILENAME and PARTITION_ROW_NUMBER when they are combined into a single string before hashing. Without this delimiter, it may be possible that distinct FILENAME, PARTITION_ROW_NUMBER pairs produce the same hash. For example, imagine the following scenario: FILENAME=FILE, ROW_NUMBER=11 FILENAME=FILE1, ROW_NUMBER=1. If FILENAME and ROW_NUMBER are combined without the ‘$’ delimiter, both instances would produce “FILE11”, leading to a hash collision. Adding the ‘$’ delimiter provides clarity-FILE$11 vs FILE1$1.

In some aspects, the DT manager 128 can add the METADATA$FILENAME ‘:’ Prefix. Prepending the METADATA$FILENAME to the hash result can provide better locality for deletes and joins, as rows belonging to the same partition will have a common prefix.

In some aspects, the DT manager 128 can handle positional deletes in Iceberg tables. The DT manager 128 can process row-level deletes that create delete files, mapping out or filtering out specific rows without changing the row identities of remaining rows. This capability enables more granular change tracking when only specific rows within a file are deleted.

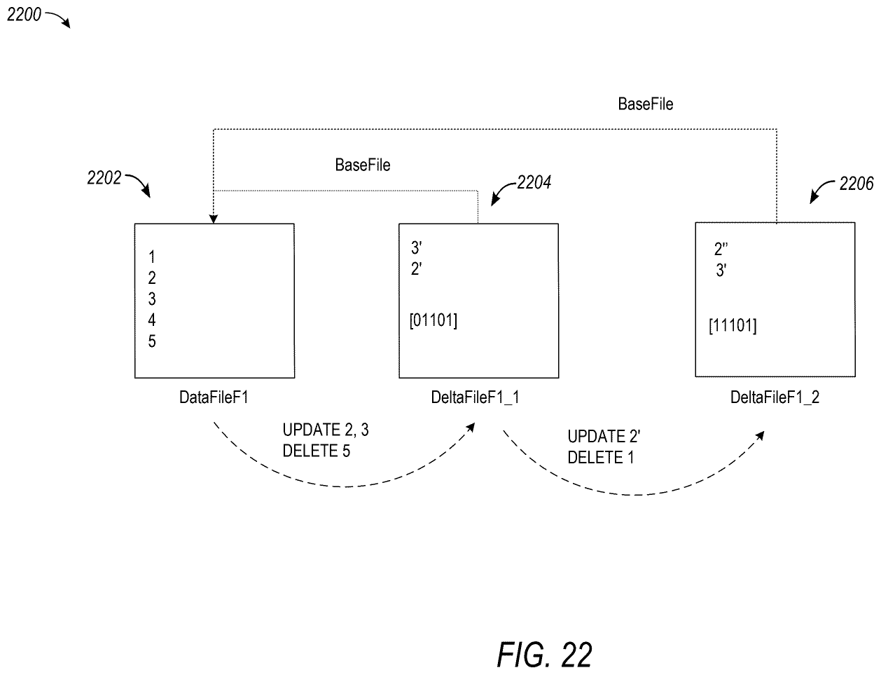

FIG. 22 is a diagram 2200 illustrating the process of merge-on-read implementation for unmanaged Iceberg tables, including the creation and management of combined partitions and delta files, in accordance with some embodiments of the present disclosure. More specifically, FIG. 22 depicts the relationship between a data file 2202, a delta file 2204, and a delta file 2206, which together reflect the current state of the data after applying updates and deletes.

In some aspects, DT manager 128 supports merge-on-read (MoR) for unmanaged Iceberg tables with both Iceberg and delta sources. During table creation and refresh, Iceberg or delta MoR representations are translated into row bitsets. In this context, delta files can be created by DML operations that delete or update rows. Each delta file is associated with one data file—its base file—and stores the difference relative to its base file. A base data file 2202 can have zero or one active delta files, and chains of delta files are not created. Instead, subsequent updates replace an existing delta file with a new one.

A combined partition can be a delta file that contains the rows obtained by applying the delta file 2204 on top of the data file 2202. This combined partition can consist of just the data file or both the data file and the delta file, depending on whether any updates or deletes have occurred. When a DML statement deletes or updates rows that are already contained in a delta file, a new delta file (such as delta file 2206) is produced. This new delta file inherits the data file 2202, the bitset, and all updated rows from the previous delta file 2204, and applies any additional changes from the current DML operation. Updated rows from the previous delta file that are not modified are copied forward into the new delta file, resulting in a copy-on-write-like update behavior between two delta files.

In the metadata representation, a single entry is created with two complete sets of file metadata for a combined partition registered in a metadata file: one set for the data file 2202 and one for the delta file 2206. The delta file has its short name, which can be unrelated to its data file. The compute service manager 108 (e.g., the DT manager 128) can register the delta file representing the combined partition in the same way as a data file, including file metadata and column endpoints in a delta metadata file, and also writes the data file's metadata into the delta file's metadata section. For a combined partition registration of data and delta files, the execution platform 110 can compute the accurate column endpoints for all surviving rows from the data file and the updated rows in the delta file, for all columns, as if the rows had been generated by the copy-on-write mechanism, and sends them to the DT manager 128 to register in a metadata file.

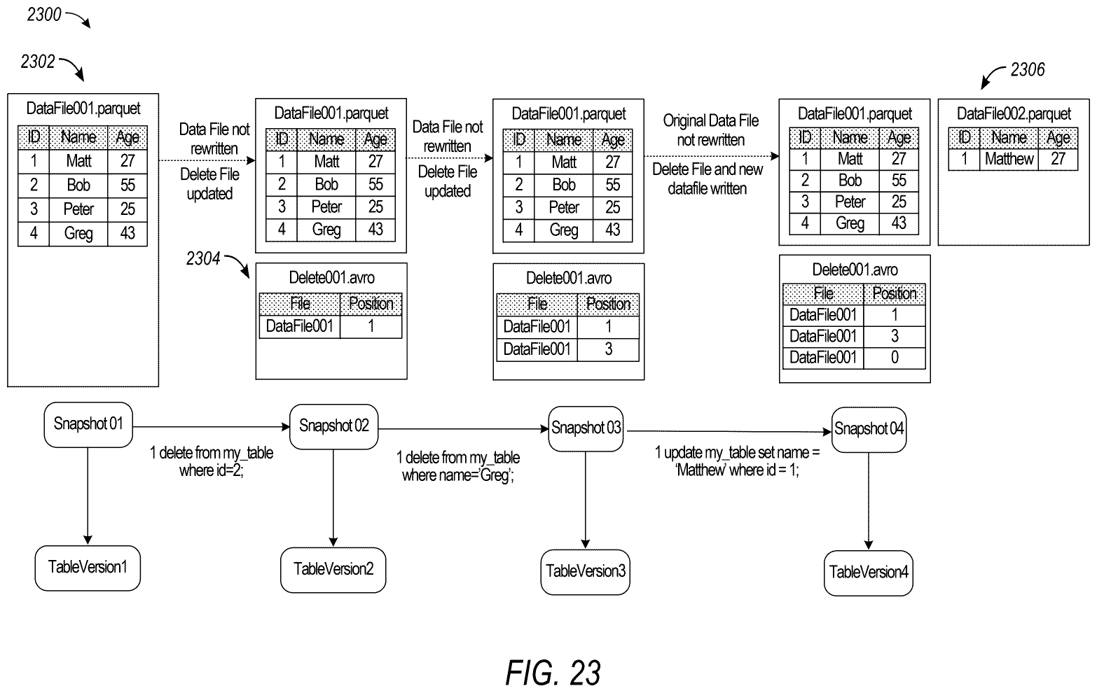

FIG. 23 illustrates a process diagram of a dynamic table versioning workflow 2300 for tracking and managing the evolution of table versions in a merge-on-read system that leverages unmanaged Iceberg sources, in accordance with some examples of the present disclosure. FIG. 23 depicts a sequence of data files and delete files, such as DataFile001.parquet (file 2302), Delete001.avro (file 2304), and DataFile002.parquet (file 2306), and their association with a series of snapshots (Snapshot 01 through Snapshot 04) and corresponding table versions (Table Version 1 through Table Version4). Each snapshot represents a specific data modification operation, such as a delete or update, and demonstrates how the system maintains the logical state of the table without rewriting the original data files.

In workflow 2300, as shown in FIG. 23, the initial state begins with a data file (DataFile001.parquet, file 2302) registered in the first snapshot (Snapshot 01), which forms TableVersion1. When a delete operation occurs, a delete file (Delete001.avro, file 2304) is created and registered in Snapshot 02, resulting in Table Version2. The delete file records the rows that have been logically deleted from the data file, allowing the system to reconstruct the current state of the table by applying the delete file on top of the data file.

If another delete or update operation is performed, a new delete file or a new data file (such as DataFile002.parquet, file 2306) is created and registered in subsequent snapshots (Snapshot 03 and Snapshot 04), resulting in new table versions (Table Version3 and Table Version4). Each new snapshot may involve the unregistration of previous partitions or files and the registration of new ones, reflecting the logical changes to the table state.

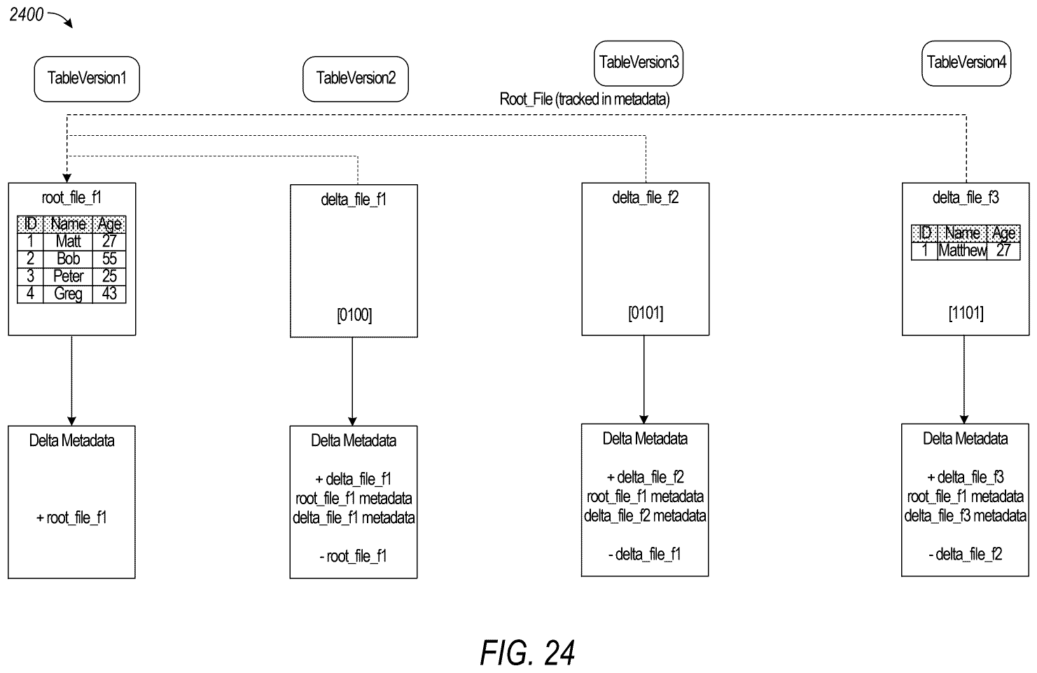

FIG. 23 is related to the merge-on-read implementation described in FIG. 22, which details the creation and management of combined partitions and delta files, and the consolidation and propagation of row-level changes illustrated in FIG. 24. FIG. 23 provides a concrete example of how partition registration and unregistration, as discussed in FIG. 24, are used to identify row-level inserts and deletes in dynamic tables with unmanaged Iceberg sources under merge-on-read semantics. The process shown in FIG. 23 also builds upon the incremental change tracking and row identifier generation techniques described in FIGS. 19-21, which address copy-on-write scenarios and the challenges of change reduction in unmanaged Iceberg tables.

By explicitly referencing the use of delete files and new data files for logical deletions and updates, FIG. 23 demonstrates the technical effect of minimizing write amplification and supporting efficient incremental refreshes. More specifically, workflow 2300 can be used to verify that each table version is consistent and that changes are propagated accurately through downstream dynamic tables. This approach can be used to track the evolution of the table state, reconstruct the current state at any snapshot, and apply only the net changes during dynamic table refreshes, as further detailed in the processes of FIGS. 19-24.

FIG. 24 is a diagram illustrating the consolidation and propagation of row-level changes through dynamic tables consuming data from unmanaged Iceberg tables using merge-on-read operations, in accordance with some embodiments of the present disclosure.

FIG. 24 illustrates diagram 2400, which shows the consolidation and propagation of row-level changes through dynamic tables consuming data from unmanaged Iceberg tables using merge-on-read operations, in accordance with some examples of the present disclosure. FIG. 24 is related to the workflow depicted in FIG. 23 and further details how changes tracked at the file and partition level are consolidated and applied as incremental updates in downstream dynamic tables.

In the examples in FIG. 23 and FIG. 24, an unmanaged Iceberg table undergoes several deletes and an update. In Table Version 1:4 rows are inserted, a partition is created, and registered in a metadata file. In Table Version 2: a single row is deleted, a combined partition with a row bitset that identifies which row was deleted is created, a combined partition is registered, and the original partition is unregistered. In Table Version 3: another row is deleted, a new combined partition is created, the combined partition contains an updated row bitset which identifies both deleted rows, a new combined partition (delta_file_f2+root_file_f1) is registered, and a previous combined partition (delta_file_f1+root_file_f1) is unregistered. In Table Version 4, a row is updated, and a new combined partition is created. The combined partition contains an updated row bitset which identifies the 2 deleted rows, and the updated row. The combined partition contains the updated rows' new value. Additionally, a new combined partition (delta_file_f3+root_file_f1) is registered, and the previous combined partition (delta_file_f2+root_file_f1) is unregistered.

In FIG. 24, the process of diagram 2400 begins with the registration and unregistration of data files and delete files, as described in the merge-on-read workflow. As new snapshots are created in the unmanaged Iceberg table, partitions or files are either registered (added) or unregistered (removed), reflecting logical inserts and deletes at the row level. In some aspects, the DT manager 128 identifies which rows have been inserted or deleted by analyzing the metadata associated with these registration events. For example, when a delete file is registered, it marks specific rows in a data file as logically deleted, while the registration of a new data file or a combined partition reflects the addition or update of rows.

The figure demonstrates how the dynamic table manager consolidates these row-level changes by comparing the sets of row identifiers present in the current and previous table versions. Only the net changes—those rows that are newly inserted or deleted—are propagated to the dynamic table. This consolidation step ensures that unchanged rows are not redundantly processed or written, thereby reducing unnecessary data movement and write amplification.

Once the net changes are determined, the dynamic table is incrementally updated to reflect the current state of the source Iceberg table. The propagation of these changes through the dynamic table enables downstream consumers and analytics to access up-to-date results without the need for full table refreshes. In this regard, FIG. 24 illustrates the process by which row-level changes, tracked via partition and file registration in a merge-on-read Iceberg table, are consolidated and applied in dynamic tables.

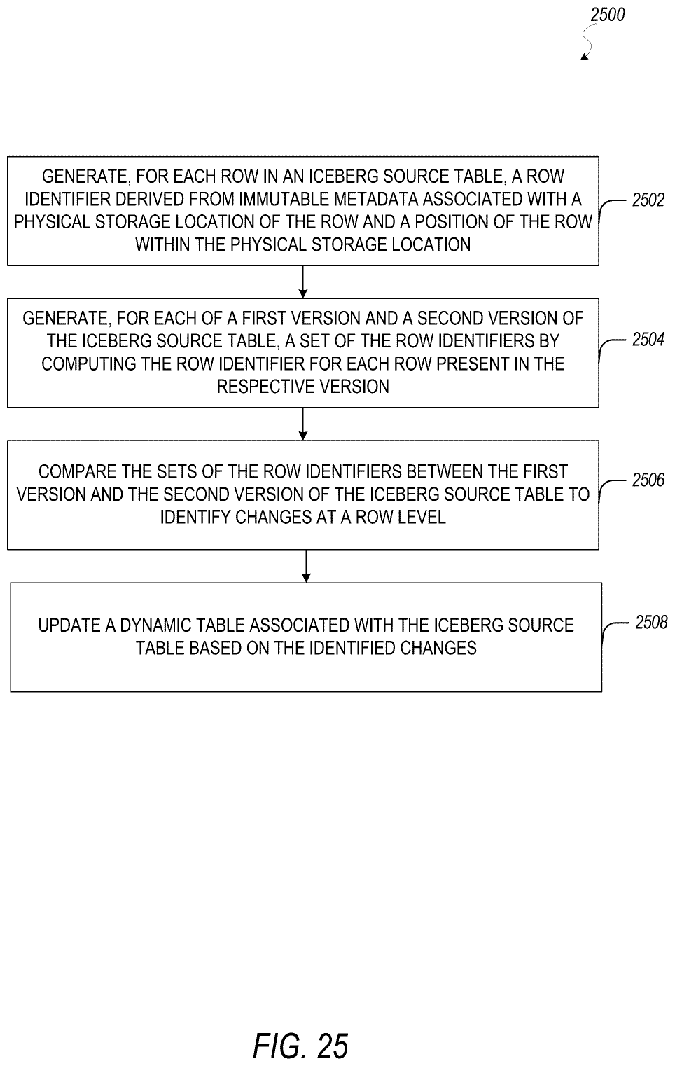

FIG. 25 is a flow diagram illustrating the operations of a database system in performing a method 2500 for configuring a dynamic table with an externally managed Iceberg source table, in accordance with some embodiments of the present disclosure. Method 2500 may be embodied in computer-readable instructions for execution by one or more hardware components (e.g., one or more processors) such that the operations of method 2500 may be performed by components of NBDS 102, such as components of the compute service manager 108 (e.g., the DT manager 128) and/or the execution platform 110 (which components may be implemented as machine 2600 of FIG. 26). Accordingly, method 2600 is described below, by way of example with reference thereto. However, method 2600 may be deployed on various other hardware configurations and is not intended to be limited to deployment within the NBDS 102.

At operation 2502, the DT manager 128 generates, for each row in an Iceberg source table, a row identifier that is derived from immutable metadata associated with the physical storage location of the row and the position of the row within that location. This process includes extracting metadata such as the file name, partition identifier, and row ordinal, and using these values to create a unique and stable identifier for each row, ensuring that each row can be tracked across different versions of the table.

At operation 2504, the DT manager 128 generates, for each of a first version and a second version of the Iceberg source table, a set of row identifiers by computing the row identifier for every row present in each respective version. This step involves scanning both versions of the table, applying the row identifier generation logic to all rows, and assembling the resulting identifiers into sets that represent the row composition of each table version.

At operation 2506, the DT manager 128 compares the sets of row identifiers between the first version and the second version of the Iceberg source table to identify changes at a row level. By analyzing which row identifiers are present in one version but not the other, the DT manager 128 determines which rows have been inserted, deleted, or remain unchanged, thereby enabling precise detection of incremental changes between table versions.

At operation 2508, the DT manager 128 updates a dynamic table associated with the Iceberg source table based on the identified changes. This operation involves applying only the net changes-such as inserting new rows, deleting removed rows, or updating modified rows-to the dynamic table, ensuring that it accurately reflects the current state of the source data while minimizing unnecessary data movement and processing.

FIG. 26 illustrates a diagrammatic representation of a machine 2600 in the form of a computer system within which a set of instructions may be executed to cause the machine 2600 to perform any one or more of the methodologies discussed herein, according to an example embodiment. Specifically, FIG. 26 shows a diagrammatic representation of machine 2600 in the example form of a computer system, within which instructions 2616 (e.g., software, a program, an application, an applet, an app, or other executable code) for causing the machine 2600 to perform any one or more of the methodologies discussed herein may be executed. For example, instructions 2616 may cause machine 2600 to execute any one or more operations of methods 1800 and 2500 (or any other technique discussed herein, for example, in connection with FIG. 4-FIG. 25). As another example, instructions 2616 may cause machine 2600 to implement one or more portions of the functionalities discussed herein. In this way, instructions 2616 may transform a general, non-programmed machine into a particular machine 2600 (e.g., the compute service manager 108 or a node in the execution platform 110) that is specially configured to carry out any one of the described and illustrated functions in the manner described herein. In yet another embodiment, instructions 2616 may configure the compute service manager 108 and/or a node in the execution platform 110 to carry out any one of the described and illustrated functions in the manner described herein.

In alternative embodiments, the machine 2600 operates as a standalone device or may be coupled (e.g., networked) to other machines. In a networked deployment, machine 2600 may operate in the capacity of a server machine or a client machine in a server-client network environment or as a peer machine in a peer-to-peer (or distributed) network environment. The machine 2600 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2616, sequentially or otherwise, that specify actions to be taken by the machine 2600. Further, while only a single machine 2600 is illustrated, the term “machine” shall also be taken to include a collection of machines 2600 that individually or jointly execute the instructions 2616 to perform any one or more of the methodologies discussed herein.

Machine 2600 includes processors 2610, memory 2630, and input/output (I/O) components 2650 configured to communicate with each other, such as via a bus 2602. In some example embodiments, the processors 2610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2612 and a processor 2614 that may execute the instructions 2616. The term “processor” is intended to include multi-core processors 2610 that may comprise two or more independent processors (sometimes referred to as “cores”) that may execute instructions 2616 contemporaneously. Although FIG. 26 shows multiple processors 2610, machine 2600 may include a single processor with a single core, a single processor with multiple cores (e.g., a multi-core processor), multiple processors with a single core, multiple processors with multiple cores, or any combination thereof.

The memory 2630 may include a main memory 2632, a static memory 2634, and a storage unit 2636, all accessible to the processors 2610, such as via the bus 2602. The main memory 2632, the static memory 2634, and the storage unit 2636 store the instructions 2616, embodying any one or more of the methodologies or functions described herein. The instructions 2616 may also reside, wholly or partially, within the main memory 2632, within the static memory 2634, within machine storage medium 2638 of the storage unit 2636, within at least one of the processors 2610 (e.g., within the processor's cache memory), or any suitable combination thereof, during execution thereof by the machine 2600.

The I/O components 2650 include components to receive input, provide output, produce output, transmit information, exchange information, capture measurements, and so on. The specific I/O components 2650 that are included in a particular machine 2600 will depend on the type of machine. For example, portable machines such as mobile phones will likely include a touch input device or other such input mechanisms, while a headless server machine will likely not include such a touch input device. It will be appreciated that the I/O components 2650 may include many other components that are not shown in FIG. 26. The I/O components 2650 are grouped according to functionality merely to simplify the following discussion. The grouping is in no way limiting. In various example embodiments, the I/O components 2650 may include output components 2652 and input components 2654. The output components 2652 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 2650 may include communication components 2664 operable to couple the machine 2600 to a network 2680 or devices 2670 via a coupling 2682 and a coupling 2672, respectively. For example, the communication components 2664 may include a network interface component or another suitable device to interface with the network 2680. In further examples, communication components 2664 may include wired communication components, wireless communication components, cellular communication components, and other communication components to provide communication via other modalities. The device 2670 may be another machine or any of a wide variety of peripheral devices (e.g., a peripheral device coupled via a universal serial bus (USB)). For example, as noted above, machine 2600 may correspond to any one of the compute service manager 108 or the execution platform 110, and device 2670 may include the client device 114 or any other computing device described herein as being in communication with the NBDS 102 or the cloud storage platform 104.

The various memories (e.g., 2630, 2632, 2634, and/or memory of the processor(s) 2610 and/or the storage unit 2636) may store one or more sets of instructions 2616 and data structures (e.g., software) embodying or utilized by any one or more of the methodologies or functions described herein. These instructions 2616, when executed by the processor(s) 2610, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 2680 or a portion of network 2680 may include a wireless or cellular network, and the coupling 2682 may be a Code Division Multiple Access (CDMA) connection, a Global System for Mobile communications (GSM) connection, or another cellular or wireless coupling. In this example, the coupling 2682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2616 may be transmitted or received over network 2680 using a transmission medium via a network interface device (e.g., a network interface component included in the communication components 2664) and utilizing any one of several well-known transfer protocols (e.g., hypertext transfer protocol (HTTP)). Similarly, instructions 2616 may be transmitted or received using a transmission medium via coupling 2672 (e.g., a peer-to-peer coupling) to device 2670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2616 for execution by the machine 2600 and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising: at least one hardware processor; and at least one memory storing instructions that cause the at least one hardware processor to perform operations comprising: generating, for each row in an Iceberg source table, a row identifier derived from immutable metadata associated with a physical storage location of the row and a position of the row within the physical storage location; generating, for each of a first version and a second version of the Iceberg source table, a set of the row identifiers by computing the row identifier for each row present in the respective version; comparing the sets of the row identifiers between the first version and the second version of the Iceberg source table to identify changes at a row level; and updating a dynamic table associated with the Iceberg source table based on the identified changes.

In Example 2, the subject matter of Example 1 includes functionalities such as, wherein the physical storage location comprises a file associated with the Iceberg source table or a partition within the file, and the operations further comprising: determining the immutable metadata based on at least one of: a file name of the file, a file path associated with the file, a partition identifier of the partition, a table identifier of the Iceberg source table, and the position of the row.

In Example 3, the subject matter of Example 2 includes functionalities such as wherein the generating of the row identifier comprises: concatenating at least one of the file name or the file path with the position of the row to obtain a concatenated value; and applying a hash function to the concatenated value to generate the row identifier.

In Example 4, the subject matter of Examples 1-3 includes functionalities such as the operations further comprising: performing a copy-on-write update process on the Iceberg source table to detect newly added or removed files; and determining the changes at the row level based on presence or absence of row identifiers in the newly added or removed files.

In Example 5, the subject matter of Examples 1-4 includes functionalities such as, the operations further comprising: performing a merge-on-read update to parse delta files of one or more base files of the Iceberg source table to detect changes to the one or more base files.

In Example 6, the subject matter of Example 5 includes functionalities such as, the operations further comprising: reconstructing a current state of each row of the Iceberg source table by applying the changes to the one or more base files; and determining the changes at the row level based on the current state of each row of the Iceberg source table.

In Example 7, the subject matter of Examples 1-6 includes functionalities such as the operations further comprising: storing a mapping of the row identifiers to row data of the Iceberg source table; and performing a refresh of the dynamic table based on the mapping.

In Example 8, the subject matter of Example 7 includes functionalities such as the operations further comprising: updating the mapping of the row identifiers to row data in response to changes detected between versions of the Iceberg source table.

Example 9 is a method comprising: generating, by at least one hardware processor, for each row in an Iceberg source table, a row identifier derived from immutable metadata associated with a physical storage location of the row and a position of the row within the physical storage location; generating, for each of a first version and a second version of the Iceberg source table, a set of the row identifiers by computing the row identifier for each row present in the respective version; comparing the sets of the row identifiers between the first version and the second version of the Iceberg source table to identify changes at a row level; and updating a dynamic table associated with the Iceberg source table based on the identified changes.

In Example 10, the subject matter of Example 9 includes functionalities such as, wherein the physical storage location comprises a file associated with the Iceberg source table or a partition within the file, and the method further comprises: determining the immutable metadata based on at least one of: a file name of the file, a file path associated with the file, a partition identifier of the partition, a table identifier of the Iceberg source table, and the position of the row.

In Example 11, the subject matter of Example 10 includes functionalities such as wherein the generating of the row identifier comprises: concatenating at least one of the file name or the file path with the position of the row to obtain a concatenated value; and applying a hash function to the concatenated value to generate the row identifier.

In Example 12, the subject matter of Examples 9-11 includes functionalities such as, further comprising: performing a copy-on-write update process on the Iceberg source table to detect newly added or removed files; and determining the changes at the row level based on presence or absence of row identifiers in the newly added or removed files.

In Example 13, the subject matter of Examples 9-12 includes functionalities such as, further comprising: performing a merge-on-read update to parse delta files of one or more base files of the Iceberg source table to detect changes to the one or more base files.

In Example 14, the subject matter of Example 13 includes functionalities such as, further comprising: reconstructing a current state of each row of the Iceberg source table by applying the changes to the one or more base files; and determining the changes at the row level based on the current state of each row of the Iceberg source table.

In Example 15, the subject matter of Examples 9-14 includes functionalities such as, further comprising: storing a mapping of the row identifiers to row data of the Iceberg source table, and performing a refresh of the dynamic table based on the mapping.

In Example 16, the subject matter of Example 15 includes functionalities such as, further comprising: updating the mapping of the row identifiers to row data in response to changes detected between versions of the Iceberg source table.

Example 17 is a computer-storage medium comprising instructions that, when executed by one or more processors of a machine, configure the machine to perform operations comprising: generating, for each row in an Iceberg source table, a row identifier derived from immutable metadata associated with a physical storage location of the row and a position of the row within the physical storage location; generating, for each of a first version and a second version of the Iceberg source table, a set of the row identifiers by computing the row identifier for each row present in the respective version; comparing the sets of the row identifiers between the first version and the second version of the Iceberg source table to identify changes at a row level; and updating a dynamic table associated with the Iceberg source table based on the identified changes.

In Example 18, the subject matter of Example 17 includes functionalities such as, wherein the physical storage location comprises a file associated with the Iceberg source table or a partition within the file, and the operations further comprising: determining the immutable metadata based on at least one of: a file name of the file, a file path associated with the file, a partition identifier of the partition, a table identifier of the Iceberg source table, and the position of the row.

In Example 19, the subject matter of Example 18 includes functionalities such as, wherein the operations to generate the row identifier comprise: concatenating at least one of the file name or the file path with the position of the row to obtain a concatenated value; and applying a hash function to the concatenated value to generate the row identifier.

In Example 20, the subject matter of Examples 17-19 includes functionalities such as, the operations further comprising: performing a merge-on-read update to parse delta files of one or more base files of the Iceberg source table to detect changes to the one or more base files; reconstructing a current state of each row of the Iceberg source table by applying the changes to the one or more base files; and determining the changes at the row level based on the current state of each row of the Iceberg source table.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Example 25 is at least one machine-readable storage including machine-readable instructions, which, when executed, cause a computer to implement a method or a process as claimed in any of Examples 1-20.

Example 26 is a computer program comprising instructions which, when the program is executed by a computer, cause the computer to carry out one or more operations according to at least one of Examples 1-20.

Example 27 is an apparatus comprising means to perform a method or a process as recited by at least one of Examples 1-20.

Example 28 is a computer storage medium that stores instructions for execution by one or more processors of a communication device, the instructions to cause the communication device to perform a method or a process as recited by at least one of Examples 1-20.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
generating, for each row in an Iceberg source table, a row identifier derived from immutable metadata associated with a physical storage location of the row and a position of the row within the physical storage location;
generating, for each of a first version and a second version of the Iceberg source table, a set of the row identifiers by computing the row identifier for each row present in the respective version;
comparing the sets of the row identifiers between the first version and the second version of the Iceberg source table to identify changes at a row level; and
updating a dynamic table associated with the Iceberg source table based on the identified changes.

2. The system of claim 1, wherein the physical storage location comprises a file associated with the Iceberg source table or a partition within the file, and the operations further comprising:
determining the immutable metadata based on at least one of: a file name of the file, a file path associated with the file, a partition identifier of the partition, a table identifier of the Iceberg source table, and the position of the row.

3. The system of claim 2, wherein the generating of the row identifier comprises:
concatenating at least one of the file name or the file path with the position of the row to obtain a concatenated value; and
applying a hash function to the concatenated value to generate the row identifier.

4. The system of claim 1, the operations further comprising:
performing a copy-on-write update process on the Iceberg source table to detect newly added or removed files; and
determining the changes at the row level based on presence or absence of row identifiers in the newly added or removed files.

5. The system of claim 1, the operations further comprising:
performing a merge-on-read update to parse delta files of one or more base files of the Iceberg source table to detect changes to the one or more base files.

6. The system of claim 5, the operations further comprising:
reconstructing a current state of each row of the Iceberg source table by applying the changes to the one or more base files; and
determining the changes at the row level based on the current state of each row of the Iceberg source table.

7. The system of claim 1, the operations further comprising:
storing a mapping of the row identifiers to row data of the Iceberg source table; and
performing a refresh of the dynamic table based on the mapping.

8. The system of claim 7, the operations further comprising:
updating the mapping of the row identifiers to row data in response to changes detected between versions of the Iceberg source table.

9. A method comprising:
generating, by at least one hardware processor, for each row in an Iceberg source table, a row identifier derived from immutable metadata associated with a physical storage location of the row and a position of the row within the physical storage location;
generating, for each of a first version and a second version of the Iceberg source table, a set of the row identifiers by computing the row identifier for each row present in the respective version;
comparing the sets of the row identifiers between the first version and the second version of the Iceberg source table to identify changes at a row level; and
updating a dynamic table associated with the Iceberg source table based on the identified changes.

10. The method of claim 9, wherein the physical storage location comprises a file associated with the Iceberg source table or a partition within the file, and the method further comprises:
determining the immutable metadata based on at least one of: a file name of the file, a file path associated with the file, a partition identifier of the partition, a table identifier of the Iceberg source table, and the position of the row.

11. The method of claim 10, wherein the generating of the row identifier comprises:
concatenating at least one of the file name or the file path with the position of the row to obtain a concatenated value; and
applying a hash function to the concatenated value to generate the row identifier.

12. The method of claim 9, further comprising:
performing a copy-on-write update process on the Iceberg source table to detect newly added or removed files; and
determining the changes at the row level based on presence or absence of row identifiers in the newly added or removed files.

13. The method of claim 9, further comprising:
performing a merge-on-read update to parse delta files of one or more base files of the Iceberg source table to detect changes to the one or more base files.

14. The method of claim 13, further comprising:
reconstructing a current state of each row of the Iceberg source table by applying the changes to the one or more base files; and
determining the changes at the row level based on the current state of each row of the Iceberg source table.

15. The method of claim 9, further comprising:
storing a mapping of the row identifiers to row data of the Iceberg source table, and performing a refresh of the dynamic table based on the mapping.

16. The method of claim 15, further comprising:
updating the mapping of the row identifiers to row data in response to changes detected between versions of the Iceberg source table.

17. A computer-storage medium comprising instructions that, when executed by one or more processors of a machine, configure the machine to perform operations comprising:
generating, for each row in an Iceberg source table, a row identifier derived from immutable metadata associated with a physical storage location of the row and a position of the row within the physical storage location;
generating, for each of a first version and a second version of the Iceberg source table, a set of the row identifiers by computing the row identifier for each row present in the respective version;
comparing the sets of the row identifiers between the first version and the second version of the Iceberg source table to identify changes at a row level; and
updating a dynamic table associated with the Iceberg source table based on the identified changes.

18. The computer-storage medium of claim 17, wherein the physical storage location comprises a file associated with the Iceberg source table or a partition within the file, and the operations further comprising:
determining the immutable metadata based on at least one of: a file name of the file, a file path associated with the file, a partition identifier of the partition, a table identifier of the Iceberg source table, and the position of the row.

19. The computer-storage medium of claim 18, wherein the operations to generate the row identifier comprise:
concatenating at least one of the file name or the file path with the position of the row to obtain a concatenated value; and
applying a hash function to the concatenated value to generate the row identifier.

20. The computer-storage medium of claim 17, the operations further comprising:
performing a merge-on-read update to parse delta files of one or more base files of the Iceberg source table to detect changes to the one or more base files;
reconstructing a current state of each row of the Iceberg source table by applying the changes to the one or more base files; and
determining the changes at the row level based on the current state of each row of the Iceberg source table.
